(19) United States
(12) Patent Application Publication
(10) Pub. No.: US 2025/0022087 A1
(43) Pub. Date: Jan. 16, 2025

(54) ELECTRONIC AND COMPUTER-BASED EMERGENCY OPERATING PROCEDURES FOR REGULATED FACILITIES

(71) Applicant: XCEL ENERGY INC., Minneapolis, MN (US)

(72) Inventor: Joseph Loesch, Ellsworth, WI (US)

(21) Appl. No.: 18/762,853

(22) Filed: Jul. 3, 2024

Related U.S. Application Data
(60) Provisional application No. 63/513,472, filed on Jul. 13, 2023.

(51) Int. Cl. G06Q 50/26; G06F 11/07

(52) U.S. Cl. CPC G06Q 50/265; G06F 11/0709; G06F 11/0793

(57) ABSTRACT

Disclosed are systems and methods for monitoring and responding to an event in a facility using electronic emergency operating procedures (EOPs). A supervisory computer system can perform operations including: receiving facility operational data, detecting, based on the data, an event in the facility, retrieving logic for executing an EOP set of steps, the EOP being identified for mitigating the event, executing the logic to determine conditions, steps, and manual actions to perform to mitigate the event, and generating and transmitting instructions to user devices to present a dashboard with the conditions, steps, and manual actions, the dashboard presenting an electronic version of the EOP set of steps. While executing the logic, the operations can include iteratively: determining whether the conditions, steps, and manual actions are completed, and generating updated instructions for the user devices to present the dashboard with indications indicating that the conditions, steps, and manual actions are completed.

### INCORPORATION BY REFERENCE

This application claims the priority benefit of U.S. Provisional Patent Application No. 63/513,472, filed Jul. 13, 2023, which is incorporated herein by reference in its entirety.

### TECHNICAL FIELD

This document generally describes devices, systems, methods, techniques, and computer-based platforms related to automating procedures, such as emergency operating procedures (EOPs) in regulated facilities, like nuclear power plants.

### BACKGROUND

Regulated facilities, such as commercial nuclear power plants, maintain a set of EOPs to be used in the event of a reactor accident or other type of emergency or event. The EOPs are developed based on extensive analysis from industry experts, and include step-by-step instructions for facility operators to follow in the case of an emergency, such as a reactor operating outside of expected conditions (e.g., temperature, pressure, power level). EOPs have been conventionally produced and used within a facility in a physical, printed format, such as in a laminate or paper documents. For example, during an emergency, an operator can open the laminate version of a relevant EOP and read out loud through each of the steps with an operating crew in order to address and mitigate the emergency. When a step or action is completed the user can mark or draw on the laminate or paper version of the EOPs, indicating success and/or failure of each step or action. Once the emergency ends or is mitigated, the laminate version of the EOPs may be cleaned to erase any of the markings made by the user while addressing the emergency.

These EOPs can be implemented by operating crews following accidents such as a Loss of Coolant Accident (LOCA). The operating crews can practice and train on the use of these procedures during simulator training. Proficient use of these procedures can be a large component in obtaining and maintaining an NRC Reactor Operator (RO or SRO) license. The EOP set for each power plant can be developed from a generic set of guidelines published by the Pressurized or Boiling Water Reactor Owners Groups (PWROG or BWROG). Every few years (e.g., ˜8-12 years), the PWROG or BWROG can publish a revision to the generic guidelines. The individual plants may then be obligated to revise their respective EOP sets to conform with the generic guidelines of the PWROG or BWROG. Once the PWROG or BWROG publishes revisions, an individual plant may have approximately 2 to 3 years to complete an upgrade to their EOP set(s).

### SUMMARY

This document generally describes technology for providing electronic and computer-based EOPs for use in regulated facilities, including integrating plant system monitoring computer systems with plant EOPs in regulated facilities, such as nuclear power plants. In particular, the disclosed technology can provide for robust, secure, and reliable electronic and computer-based EOPs in regulated facilities, which have conventionally relied on paper and physical copies of EOPs in order to hedge against power, communication, and other electronic failures that could render electronic and computer-based EOPs unreliable and unusable across a variety of scenarios. For example, one concern with computer-based EOPs is that, in the event of a catastrophic power failure, the digital EOP interface providing the guidance on the emergency procedure to be followed could be lost or wiped out if power to the computer system, device, and/or display providing the EOP goes down. As described throughout this document, the disclosed technology provides solutions for these and/or other problems related to computer-based EOPs while also improving the operation and execution of EOPs by integrating real time digital facility information (e.g., sensor readings, component status information) into the EOP process, which can mitigate potential human error (e.g., misreading facility information from terminal and/or paper-based procedure(s)).

The disclosed technology can provide a system monitoring accident, alarm, and/or abnormal response tool for relevant users in the facility. For example, the disclosed technology can utilize system monitoring points/parameters and computer logic to determine and complete a set of steps corresponding to an EOP when an event is detected in the facility. The disclosed technology can provide for improving manual actions performed by the users in the facility to mitigate or otherwise respond to the event. Sometimes, the computer logic can complete one or more EOP steps automatically and update the steps without operator or other user input. The computer logic can also determine when to require human verification of conditions and/or EOP steps throughout a completion of the EOP steps. The computer logic can also be configured to replicate user input, progress through the EOP steps, and/or other data across displays of multiple different user devices, which can allow users throughout the facility to monitor the EOP steps progress regardless of their locations. The computer logic can be configured to record any of the user input, progress through the EOP steps, other data (e.g., facility data), and/or time sequences of the progress, which can be used for training the users to improve their responses to the event and completion of the EOP steps.

Accordingly, the disclosed technology can provide dashboards, graphical user interfaces (GUIs), and other visual presentations for presenting electronic versions of EOPs to be followed during emergencies or other types of events in the facility. A window or other visual presentation can display, for each EOP step, a status of the step. The window can have a background color or other visual indicia that can visually and easily guide a user to perform appropriate actions. The dashboards can include prompts requiring manual action to be performed by relevant users in the facility. The dashboards can include prompts requiring human verification of one or more EOP step completion determinations made by a computer system implementing computer logic or other algorithms. The computer logic can be supported by a trained or programmed model, in some implementations.

The disclosed dashboards can provide visual presentations of EOPs for pressurized water reactors (PWRs) on user devices that is uncomplicated, user-friendly, and mimics or otherwise replicates a look of traditional paper versions of EOPs. The visual presentation can use a human machine interface (HMI) and/or computer tablet format. For example, the visual presentation of the EOPs can have a same color (e.g., black font on white background), format (e.g., two-column layout), spacing of steps to be performed or checked, font style and relative size, and numbering of pages as the paper versions of the EOPs, which relevant users (e.g., licensed operators) are accustomed to. Similarly, the disclosed technology can provide visual presentations of EOPs for boiling water reactors (BWRs) that mimic or otherwise replicate paper versions of flowcharts used for EOP implementation. For example, same or similar size-display can be used as that for the paper/manual version of the EOPs for BWRs.

More generally, the disclosed technology can provide a platform for user devices that presents an information dashboard (e.g., information about components in the facility), one or more step status windows or screens, and action buttons and/or links. The information dashboard can present information such as a continuous action monitor, a foldout page monitor, and/or a release status display (e.g., emergency action level and/or release status). The information dashboard can include developed computer logic described herein and/or background colors or other indicia to visually and easily guide a user through appropriate actions. Sometimes, the information dashboard can always be displayed/presented outside of an EOP procedure window in order to alert a relevant user (e.g., operator) if and/or when any condition is met and/or needing action. The platform may present minimal additional features in order to prevent information overload and/or accidental screen changes during an EOP implementation. This can promote human factoring when switching between the mobile or electronic version of the EOPs and the paper version, such as while a user (e.g., operator) may be under duress during an accident or other event at the facility. Additionally, the similarities of the electronic version of the EOPs and the paper version can minimize any required training for using the electronic version. Since the electronic and paper versions can be nearly identical, if a computer system fails (or partially fails) while an accident is in progress and the electronic version of the EOPs cannot be used, control room operators can easily and quickly revert to the paper version because they may know which procedure, page, and/or step was last performed. Accordingly, they can open the paper version of the EOP procedure and continue through the steps with minimal interruption.

The dashboards, visual presentations, and platforms described herein can be presented at the devices of different users throughout the facility, thereby allowing real-time visualization and communication about status of EOP completion and progress. The disclosed technology provides an ability to view EOP progress in real-time from any workstation or device either from a directly connected station or over a network, such as LAN. This can be beneficial for emergency response facilities during accident or drill conditions (e.g., Emergency Operating Facility (EOF), Technical Support Center (TSC), etc). This feature can also include a free-form method of communication between emergency centers and a control room similar to a chat feature in order to eliminate or reduce a need for voice communications over phones or radios. As a result, emergencies can be handled efficiently and quickly. Similarly, the disclosed technology can create an ability to communicate (two-way) through the platform to operators outside of the control room to perform required EOP actions in a timely fashion. This can include an ability for outplant operators to mark EOP steps complete, in progress etc.

The disclosed technology can also provide built-in human checkpoints during EOP implementations. These checkpoints can be designed and programed into the computer-based platform. The platform can leverage data from a non-safety-related computer to determine step and EOP progression statuses. Not every EOP step may require a human checkpoint built in, however steps that have high consequences if performed incorrectly can have built-in human checkpoints. Examples where these checkpoints may be important include but are not limited to EOP transactions, time critical actions, and confirmation of major action category completion.

The disclosed technology can also provide additional features to improve completion of EOPs. The disclosed technology can provide an ability for users to manually mark EOP steps as complete or in-progress for data tracking, collection, and/or timing purposes. The disclosed technology can also provide an ability to flag certain steps or decision points (such as EOP transitions) as requiring independent confirmation/verification by an operator, such as by using only the paper-based EOPs and/or control board indications. Visual presentations of the EOP steps can also include user-selectable and accessible links to background and/or basis information for each EOP step to help the relevant user understand the step and how to act in accordance with the EOPs. Similarly, the visual presentations can include forward and/or backward links to other applicable EOPs in a location that may be needed, including an option to return to a current step that is in effect. Moreover, the disclosed technology can include an EOP step completion tracking tool (e.g., running in the background of other operations and processes) for timing-purposes and tracking completion of the EOP steps (such as EOP steps that may require manual actions). Similarly, the disclosed technology can provide an EOP step error-tracking tool (running in the background) which can identify EOPs steps not completed correctly, log such steps, and prompt the crew to recover the corresponding action(s). As an illustrative example, a step can direct stopping feedwater (FW) flow but the logic may identify that this action was not completed based on remaining flow data received from computing systems/controllers in the facility. Accordingly, the logic described herein can provide/present a pop-up window to re-perform the action or provide contingencies at one or more user devices.

The additional features can also include an expected plant alignment tool that can identify off-normal alignments, prioritize them, and provide guidance to perform manual action to establish the correct alignment. The disclosed technology can provide selectable options in the visual presentations for additional contingency actions when a response not obtained (RNO) indication is made/provided. Moreover, the disclosed technology can provide an ability to jump directly back and forward to steps that may require continuous action when a condition is met. The disclosed technology can further be applicable to other transient response procedure types such as Alarm Response Procedures, Abnormal Operating Procedures, and EOP Flowcharts utilized at BWRs.

Unlike traditional implementation of paper version EOPs, using the disclosed technology, not all EOP steps may need to be read out loud. Using the traditional paper-based EOPs, an operating crew must read, repeat back, and complete numerous steps not directly related to mitigating the accident that is being experienced. For example, during a design base Steam Generator Tube Rupture, the operating crew must complete at least 25 steps not directly related to the accident before taking a first action required to mitigate the accident (e.g., Isolate Flow From Ruptured SG). The disclosed technology, on the other hand, can monitor plant conditions and direct the appropriate mitigating action as soon as the condition requiring the action is met. EOP steps that may verify expected system responses can be automatically completed and the disclosed technology can continue to monitor for and flag unexpected system responses for prompt action. Time-critical and time-sensitive action (TCOA, TSOA) response times can be improved, especially since not all the steps would be required to be read out loud during an emergency where those steps may not be relevant to mitigating the emergency. Not reading all the steps out load can also prevent communication errors and maximize efficient accident mitigation. For example, steps that the disclosed technology may determine to be complete or not applicable may not need to be read out loud as long as administrative controls also exist to ensure the EOP flow is consistent with the paper-based version. Similarly, the disclosed technology can allow for certain EOP steps and/or sections (such as attachments) to be assigned to a particular user, for completion without communicating each step. Communication of required EOP actions outside of a control room may also occur through an alternate platform so long as adequate checks and balances are in place to ensure effective communication.

Sometimes, the disclosed technology can also be used for timing validation (e.g., TCOA/TSOA). As an illustrative example, if the disclosed platform is reliant on off-site power, it would be appropriate to validate timing associated with events for which off-site power is lost using only the paper-based version. However, if the disclosed platform is not reliant on off-site power, it can be appropriate to validate timing using the electronic version.

One or more embodiments described herein can include a system for monitoring and responding to an event in a facility using electronic emergency operating procedures (EOPs), the system including: a supervisory computer system of the facility, the supervisory computer system being configured to perform operations including: receiving facility operational data from at least one facility data source, detecting, based on the facility operational data, an event in the facility, retrieving, from a data store, logic for executing an EOP set of steps, the EOP being identified for mitigating the detected event, executing the logic to determine one or more of conditions, steps, and manual actions to be performed to mitigate the detected event, generating and transmitting instructions to one or more of a group of user devices to present, as graphical user interface (GUI) displays, a dashboard with the one or more conditions, steps, and manual actions to be performed, the dashboard presenting an electronic version of the EOP set of steps, and while executing the logic, iteratively: determining whether the one or more conditions, steps, and manual actions are completed by the supervisory computer system or manually by a user based on user input received from the one or more of the group of user devices, generating and transmitting updated instructions to the one or more of the group of user devices to present the dashboard with indications indicating that the one or more conditions, steps, and manual actions are completed. The system can also include a group of user devices in network communication with the supervisory computer system, each of the group of user devices being configured to perform operations including: presenting the dashboard with real-time updates of a status of completing the EOP set of steps to mitigate the detected event, receiving user input indicating verification of the one or more conditions, steps, and manual actions to complete for the EOP set of steps, and transmitting the user input to the supervisory computer system, the supervisory computer system being configured to (i) iteratively determine, based on the user input, whether the one or more conditions, steps, and manual actions are completed and (ii) generate and transmit the updated instructions to the one or more of the group of user devices to present the dashboard with indications indicating that the one or more conditions, steps, and manual actions are completed.

In some implementations, the embodiments described herein can optionally include one or more of the following features. For example, the at least one facility data source can include at least one of facility equipment controllers, facility sensors, facility computing systems, and a data store. The event can be an emergency or accident. The event can be an event that requires a reactor trip. The retrieved logic can include, for each step in the EOP set of steps, data input mapping, step logic, output fields and information, user input prompts and verifications, and links to one or more next steps in the EOP set of steps.

Sometimes, the supervisory computer system performs operations further including: recording the one or more conditions, steps, and manual actions that are completed by the supervisory computer system or manually by the user based on the user input received from the one or more of the group of user devices, and determining training instructions for at least one user in the facility based on the recorded conditions, steps, and manual actions. Recording can include generating time sequence data of progress through each step of the EOP set of steps. Determining training instructions can include: determining, for each step of the EOP set of steps, whether the step was performed according to one or more step-completion criteria.

Presenting the dashboard with real-time updates of a status of completing the EOP set of steps to mitigate the detected event can include providing a version of the dashboard at the user device for monitoring progress through the EOP set of steps to mitigate the detected event. The supervisory computer system can include an EOP subsystem that can be configured to execute the logic to present and perform one or more steps in the EOP set of steps. The EOP subsystem can further be configured to: load an EOP data object corresponding to the EOP set of steps, and execute the logic based on loading the EOP data object.

The supervisory computer system can be configured to execute computer logic to automatically perform at least one of the one or more conditions, steps, and manual actions to complete for the EOP set of steps. The computer logic can be supported by a programmed model, the model having been trained to determine when to prompt one or more users at the plurality of user devices to perform at least one of the manual actions or a verification action during completion of the EOP set of steps.

In some implementations, the electronic version of the EOP can include an action response column and a response not obtained column. Sometimes, the electronic version of the EOP can replicate a paper version of the EOP. The electronic version of the EOP can include a selectable option for marking an action as complete. The electronic version of the EOP can include a selectable option for marking an action is unable to be performed. The electronic version of the EOP further can include an informational page presented concurrently with the EOP set of steps, the informational page presenting information about performing each of the EOP set of steps. The electronic version of the EOP further can include an indication of whether a continuous action is required during completion of the EOP set of steps.

Sometimes, presenting the dashboard with real-time updates of a status of completing the EOP set of steps to mitigate the detected event can include presenting output for completion of a step of the EOP set of steps in a first indicia and presenting output for incompletion of a step of the EOP set of steps in a second indicia. The first indicia can be green highlighting and the second indicia can be red highlighting. The first indicia can be blue highlighting and the second indicia can be orange highlighting.

The operations further can include: detecting a system or network failure and generating and returning instructions to at least one of the group of user devices for continuing through the EOP set of steps within a system or network connection. The instructions can prompt a user at the at least one user device to continue through the EOP set of steps using a paper-version of the EOP set of steps. The operations further can include: printing information for each completed step in the EOP set of steps to a printer or another computing device. The another computing device can include an electronically persistent display.

In some implementations, the operations can also include: storing data corresponding to completion of the EOP set of steps in a group of bits that are maintained at a group of redundant and secure memory locations. The data can be recoverable from at least a portion of the group of redundant and secure memory locations when at least one of the redundant and secure memory locations may be compromised. The at least one of the redundant and secure memory locations can be compromised by a bitflip event during the detected event in the facility. Sometimes, in response to detecting a system or network failure, the operations further can include generating and transmitting instructions to a temporary power source that causes the temporary power source to provide power to the at least one of the plurality of user devices. In response to receiving the power from the temporary power source, the at least one of the group of user devices can be configured to display a static version of the EOP set of steps, the static version presenting information indicating progress through the EOP set of steps that was displayed at the at least one of the group of user devices before the system or network failure. The operations can also include: detecting that the computer or network failure is resolved, receiving, from the at least one of the group of user devices, a scan of a paper version of the EOP set of steps that was used by a respective user to complete the EOP set of steps during the computer or network failure, processing the scan of the paper version of the EOP set of steps to identify user-inputted information in the paper version of the EOP set of steps that corresponds to completion of the EOP set of steps during the computer or network failure, automatically populating the electronic version of the EOP set of steps with the identified user-inputted information in the paper version of the EOP set of steps, and returning the populated electronic version of the EOP set of steps to the at least one of the group of user devices. Based on a determination that the detected event is ongoing, the populated electronic version of the EOP set of steps can be used, at the at least one of the group of user devices, to continue the completion of the EOP set of steps.

One or more embodiments described herein can include a system having a digital EOP device providing an electronic EOP interface and a physical document providing a physical EOP interface, the electronic EOP interface being configured to replicate the physical EOP interface.

The system can optionally include one or more of the following features. For example, the electronic EOP interface can include an action response column and a response not obtained column that can replicate corresponding columns in the physical EOP interface. The electronic EOP interface can be configured to replicate font, font size, text color, columns, and formatting of the physical EOP interface. The electronic EOP interface can include a selectable option for marking an action in a set of EOP steps as complete. The electronic EOP interface can include a selectable option for marking an action in a set of EOP steps as unable to be performed. The electronic EOP interface further can include an informational page presented concurrently with an EOP set of steps, the informational page (i) presenting information about performing each of the EOP set of steps and (ii) replicating an informational page of the physical EOP interface. The electronic EOP interface further can include an indication of whether a continuous action is required during completion of an EOP set of steps.

As another example, the electronic EOP interface further can include presenting output for completion of a step of an EOP set of steps in a first indicia and presenting output for incompletion of a step of the EOP set of steps in a second indicia. The first indicia can be green highlighting and the second indicia can be red highlighting. The first indicia can be blue highlighting and the second indicia can be orange highlighting. The digital EOP device can include a supervisory computer system having a display screen. The digital EOP device can include a group of user devices, each configured to present the electronic EOP interface. At least one of the group of user devices can be configured to receive user input indicating completion or verification of one or more actions in a set of EOP steps presented in the electronic EOP interface.

The devices, system, and techniques described herein may provide one or more of the following advantages. For example, the disclosed technology can provide for efficient and more timely determinations of EOP step completion in a facility. The disclosed technology can automatically determine multiple step completions simultaneously. The disclosed technology can provide real-time detection of events and conditions in the facility, so that certain types of steps or procedures are only presented to relevant users if needed. For example, a step to “Reset Safety Injection (SI)” can appear in EOPs approximately 20 times. The disclosed technology can monitor conditions in the facility and EOP progress of relevant users to determine when the “Reset SI” step is incomplete. Then, the disclosed technology may only direct the user to perform the step if it is needed. Similarly, the disclosed technology can automatically monitor conditions in the facility to determine and select a correct Emergency Action Level (EAL) and release status for the facility. The release status can indicate a radioactive release status to an external environment. Moreover, the disclosed technology can monitor conditions in the facility to determine when action is needed, then can direct completion of such action at an earliest possible moment. The disclosed technology can continue to monitor the conditions to determine when and if the action has been met/satisfied, to then update information presented in real-time at user devices in the facility. Such actions can include, but are not limited to, Reactor Coolant Pump (RCP) trip criteria, isolating Auxiliary Feedwater (AFW) to a faulted or ruptured Steam Generator (SG), re-energizing safety related busses (e.g., recognizing and directing the most likely and efficient success paths), and/or internal flooding (e.g., pump/valve alignment, flow, Fire Protection (FP) sprinkler flow).

The disclosed technology can also provide for real-time identification of SI termination criteria being met. Often in traditional facility setups, relevant users (e.g., crew members) may recognize SI termination too late, which can complicate recovery. The disclosed technology can also provide for automated and real-time Reactor Coolant System (RCS) temperature control following certain types of events (e.g., Main Steam Line Break (MSLB)). Traditionally, step design for RCS temperature control can be difficult to interpret and/or follow. The disclosed technology, on the other hand, can monitor conditions in the facility and determine or recognize heat-up and/or cool down, then direct users with prompts/instructions on their respective devices to perform only specific actions that may be required/needed.

For example, the disclosed technology can reduce costs in regulated facilities by providing improved setpoint maintenance for each facility. Various thresholds can trigger EOPs in the facility. A facility can sometimes have 200 or more EOP setpoints, where each setpoint has a formal engineering calculation and needs to be maintained. Sometimes, a single setpoint can appear in multiple EOPs. The setpoint value can often be impacted by plant modifications, such as instrumentation upgrades or engineering methodology changes (e.g., uncertainty). Setpoint maintenance can come at a significant cost traditionally. Setpoints can be automatically generated based on certain sets of inputs, such as instrument capabilities. Using the disclosed technology, setpoints can be automatically changed and pushed out to all appropriate places/parties/users/devices/systems within an EOP network.

The disclosed technology can also improve data collection capabilities for a facility. The data collected using the disclosed technology can be integrated with reports and records for maintenance of the facility and operations being performed in the facility. The collected data can help predict likely error points and timing of strategy completion in the facility. The data can also be used to iteratively improve and determine how to optimize various procedures performed in the facility. The data collection can capture human performance and/or system response data. Such data can be used to improve and/or refine probabilistic risk assessment (PRA) models to reflect actual error rates. The PRA models can be computer models, algorithms, and/or programs that run risk and error assessments. Such data can be used to improve EOP procedures where weak spots can be identified (e.g., automatically by a computer system, manually by a user). Such data can be used to provide risk-informed insights for potential plant modifications to improve core damage frequency (CDF). The disclosed technology can also be used to improve training of users in the facility as well as response procedures and response time in the event of emergencies or other types of events in the facility.

For example, the disclosed technology can reduce human error rates and make regulated facilities, such as nuclear power plants, safer. A majority of post-accident CDF modeled in a plant's PRA can be due to human error. The human error can be skill-based, knowledge-based, and/or rule-based). The disclosed technology can reduce knowledge and rule-based errors while electronically implementing the EOPs following an accident with computer-based techniques. The disclosed technology can also monitor for any errors that may still occur (including skill-based) and provide recovery actions before the error becomes consequential, thereby increasing safety of operations in the facility.

EOP delivery platforms using an HMI and/or computer tablet format can reduce human error during EOP implementation. Procedure and knowledge-based errors can be lowered because the disclosed platform can be designed with checks and balances to prevent these types of errors from occurring in the first place. Adequate checks and balances can exist to ensure inputs into the disclosed technology reasonably match control board indications. For example, administrative controls can assign a control room operator the responsibility to verify that indications agree with each other. In some cases, the disclosed technology may allow additional contingency (response not obtained, RNO) or recovery actions not included in the paper-based version to be available and/or used during an emergency. Recovery features can also be built into the platform to lower or otherwise avoid consequences of human skill-based errors. Additionally, responses to accidents can be streamlined to prioritize actions that may be required to mitigate a specific accident and failures being experienced.

As another example, the disclosed technology allows for implementation of EOPs to be automated. Voice or phone communications may not be required for users throughout the facility to communicate in the event of an emergency and completion of EOPs. Instead, real-time updates and instructions can be provided through a platform that is provided on user devices so that certain steps in EOP implementation can be performed timely and more efficiently than with traditional voice or phone communications. Similarly, parameters, values, and/or trends associated with the facility can be integrated into the computer platform to make decision-tree errors less likely. The disclosed technology can also allow for emergency plan implementation (e.g., classification, notification), which can be integrated into the platform to allow relevant users to remain in oversight roles. EOP progress can also be monitored in real-time to allow for efficient and timely support of a control room or other relevant users in the facility.

As another example, the disclosed technology can improve accident oversight in the facility. Traditionally, accident oversight can be provided by a Shift Manager (SM) and Shift Technical Advisor (STA) while a Control Room Supervisor (CRS) and Reactor Operators (RO) implement EOP steps. The disclosed technology may not only allow for more effective accident oversight but also force the oversight function to be independent from the CRS and RO implementation of the EOP steps. The STA can, for example, be responsible to monitor the facility and respond using diverse indications as well as the paper-based version of the EOPs to ensure the accident mitigation strategy and critical safety functions remain intact. This can also facilitate a seamless transition back to the paper-based EOPs in the event that the electronic version of the EOPs becomes unavailable (e.g., a computer network or computer system or device fails). Traditionally, the SM may be distracted from the oversight position for significant periods of time to perform their Emergency Director function. The disclosed technology, on the other hand, can include a sub-tool to aid in the prompt and accurate EAL classification as well as to complete any required notification actions, thereby allowing the SM more time to stay in the oversight position.

Similarly, the disclosed technology can reduce or eliminate a various of types of errors that may occur with traditional paper-based versions of the EOPs. Implementation of electronic versions of EOPs can no longer require voice or phone communications, and instead orders to perform certain steps can be provided through devices of relevant users. This can reduce potential communication errors that otherwise may arise with traditional paper-based versions of the EOPs. Facility indications (e.g., parameters, values, trends) can also be integrated into the disclosed technology to make decision tree errors less likely. The disclosed technology can track successful completion of EOP actions and detect performance errors. According to those performance error detections, the disclosed technology can provide for automatically determining and directing recovery actions. E-plan implementation (e.g., classification, notification) can also be integrated with the disclosed technology to allow relevant users to have more time to remain in particular roles, such as an oversight role. Additionally, EOP progress can be monitored in real-time by EP facilities, thereby allowing more efficiently and timely support of a control room addressing an emergency or other event and thus reducing overall human errors that may result during mitigation of the event.

The disclosed technology can reduce training and implementation costs. For example, using the disclosed technology can result in Licensed Operator Requalification (LOR) simulator sessions to be shorter and more effective than using traditional paper-based EOPs. The disclosed technology can save operator and training time as well as money.

Moreover, the disclosed technology can be applied to all different types of regulated facilities, including but not limited to nuclear power plants. Since the disclosed technology can operate using data from system-monitoring computer systems already installed in nuclear plants, it can be easy, economical, and quick to install the disclosed technology in such existing systems.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram of a system for providing a facility monitoring accident, alarm, and/or abnormal response tool to users, such as operators, in a facility to complete EOPs for mitigating a detected event in the facility.

FIG. 2 is a system diagram of components and data objects using the disclosed techniques for providing a facility monitoring response tool to users in the facility.

FIG. 3 is a flowchart of an illustrative process for executing computer logic to perform an EOP set of steps that can mitigate a detected event in a facility.

FIG. 4 illustrates an example electronic version of an EOP for mitigating a detected event in a facility.

FIGS. 5A and 5B illustrate another example electronic version of an EOP for mitigating a detected event in a facility.

FIGS. 6A, 6B, and 6C illustrate another example electronic version of an EOP for mitigating a detected event in a facility.

FIGS. 7A, 7B, and 7C is a flowchart of an illustrative process for mitigating an SGTR that occurs at a PWR using the disclosed techniques.

FIG. 8 is another system diagram of components and data objects using the disclosed techniques for making computer-based determinations about conditions in a facility and performance of EOP steps in response to a detected event in the facility.

FIGS. 9A, 9B, 9C, 9D, 9E, 9F, and 9G illustrate example graphical user interface (GUI) displays presenting real-time progress through steps of an electronic version of an EOP with computer-based determinations and human checkpoints.

FIGS. 10A, 10B, 10C, and 10D illustrate example electronic versions of an EOP set of steps and corresponding computer logic that is executed to determine output corresponding to each step.

FIG. 11 is a flowchart of a process for maintaining continuous progress through and completion of an EOP set of steps when an electronic version of the EOP is unavailable or inaccessible.

FIG. 12 is a conceptual diagram of a system for replicating user interactions with an electronic version of an EOP set of steps across multiple different user devices associated with a facility having a detected event.

FIG. 13 is a flowchart of a process for training users in a facility to improve performance of an EOP set of steps based on data that is collected and recorded during completion of an electronic version of the EOP set of steps.

FIG. 14 is a schematic diagram that shows an example of a computing device and a mobile computing device.

Like reference symbols in the various drawings indicate like elements.

### DETAILED DESCRIPTION OF ILLUSTRATIVE EMBODIMENTS

This document generally relates to systems, methods, techniques, technology, and computer-based platforms for system monitoring of responses to various types of events in a facility, such as a nuclear power plant or other regulated facility, based on EOPs. The disclosed technology may improve nuclear safety and/or reduce long-term cost of maintaining EOPs and training in the facility. The disclosed technology can directly integrate the facility's system monitoring computer data with the facility's EOPs. System monitoring parameters and computer logic can be used to check and automatically complete one or more EOP steps to an extent possible without human interaction. The disclosed technology can also prompt or otherwise require relevant users, such as facility operators, to perform manual actions and checks during completion of the EOP steps. The disclosed technology can provide a platform or dashboard with electronic versions of the EOPs that integrates with the facility's system monitoring computer to provide inputs into each EOP step and complete those steps automatically and efficiently in a user-friendly visual manner. The electronic version of the EOPs can mimic a look and appearance of a traditional paper version of the EOPs. This can be beneficial for human factoring to ensure that an end user can switch between paper and computer platforms easily and efficiently (which may occur due to a potential loss of computer during an emergency or other network connectivity or failure).

The disclosed dashboard/platform can also be replicated across multiple user devices throughout the facility to allow such users to monitor and follow along with completion of the EOP steps during the emergency. Moreover, the disclosed technology can provide recording mechanisms to track progress of the uses through the EOP steps, which can then be used to determine training improvements and ways in which to improve user performance of manual actions in the EOP steps.

The disclosed technology can apply to PWR EOPs and BWR EOPs. PWRs require adding/maintaining enough pressure so that water does not boil but remains at a particular high temperature. BWRs product steam in a reactor core, which is then used to make turbines turn in the facility. In comparison to PWR EOPs described throughout this disclosure in various illustrative examples, BWR EOPs can include a flowchart that a user works through, with decision trees based on what indications the user may identify. The user also may watch for different conditions that may occur at any time outside of the flowchart, which may cause the user to circle back and address such conditions before continuing through the flowchart. Although PWRs and BWRs have different EOPs, the respective EOPs can be visually presented and automatically implemented using the disclosed technology. Moreover, the electronic versions of the PWR EOPs and the BWR EOPs can replicate or otherwise mimic paper versions of the respective EOPs.

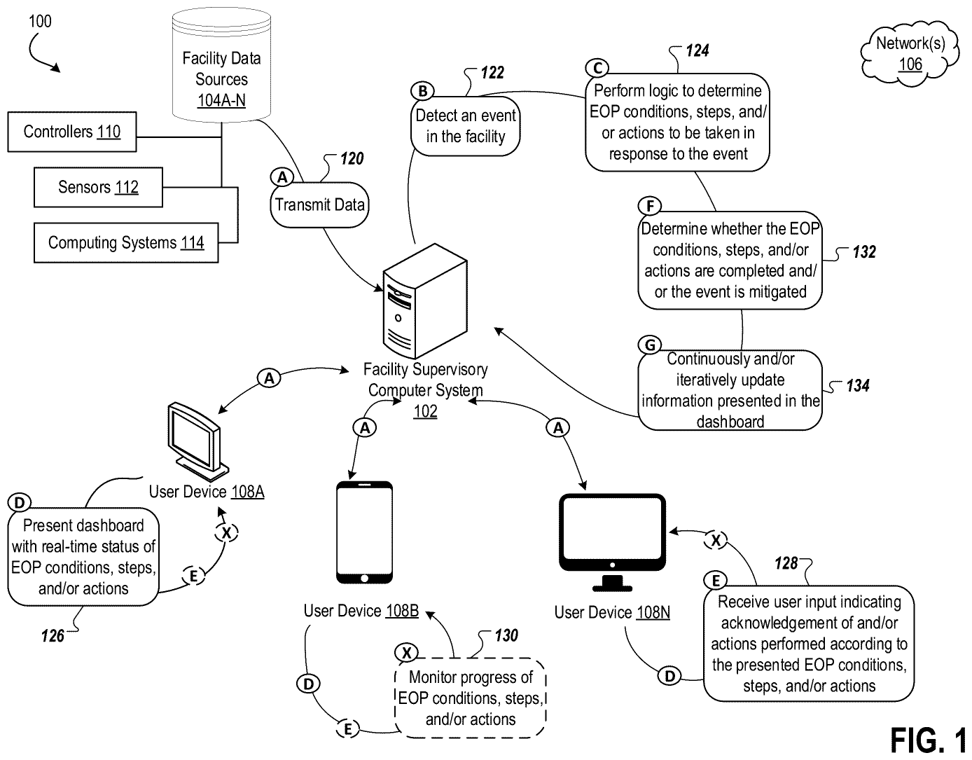

Referring to the figures, FIG. 1 is a conceptual diagram of a system 100 for providing a facility monitoring accident, alarm, and/or abnormal response tool to users, such as operators, in a facility to complete EOPs for mitigating a detected event in the facility. The system 100 can include a facility supervisory computer system 102, facility data sources 104A-N, and/or user devices 108A-N that may communicate (e.g., wired, wirelessly) via network(s) 106.

The facility supervisory computer system 102 can be any type of computer system, network of computing devices, cloud-based system, remote computing system, or other computer that can be configured to control operations and/or data associated with the facility. Sometimes, the facility supervisory computer system 102 can be a computer system in a control room of the facility being monitored and/or used by a facility control operator or other relevant user.

The facility data sources 104A-N can include any type of computing devices, computer systems, display devices, data stores, cloud-based systems, and/or databases that may be configured to collect and/or store data associated with the facility. For example, the facility data sources 104A-N can include one or more data stores, sensors 112, controllers 110, and/or other computing systems 114 in the facility. The facility data sources 104A-N can include sensors that monitor parameters/conditions of components in the facility, such as PWRs and BWRs.

The user devices 108A-N can include any type of computing devices, user devices, mobile devices, laptops, tablets, wearable devices, computer systems, and/or display devices that may be used by a variety of users in the facility. The user devices 108A-N can include input and output devices configured to present electronic versions of EOPs during emergencies in the facility, receive user input indicating one or more manual actions taken to complete one or more EOP steps, and/or act as a monitor and/or recording mechanism that allows users in the facility to track progress through EOP steps.

The electronic versions of the EOPs can be presented at one or more of the user devices 108A-N and/or the facility supervisory computer system 102. The user devices 108A-N can be located all throughout the facility, including but not limited to inside and outside of a control room of the facility.

Still referring to the system 100 in FIG. 1, data can be transmitted to the facility supervisory computer system 102 from one or more of the facility data sources 104A-N and/or the user devices 108A-N (block A, 120). The transmitted data can include, as an illustrative example, measured sensor values for one or more components in the facility that exceed safe or expected threshold levels.

The facility supervisory computer system 102 can detect an event in the facility based on the transmitted data (block B, 122). The event can be an emergency. The system 102 can detect the event based on determining that measured values or other transmitted data exceeds expected or safe threshold ranges for the facility. The threshold ranges can be checked for various different instruments, equipment, and/or equipment in the facility. As merely illustrative examples, such instruments and respective ranges can include pressurizer pressure, accumulator pressure, RCS pressure, pressurizer level, RCS average temperature, RCS hot leg temperature, RCS cold leg temperature, RVLIS full range level, RVLIS dynamic level, RVLIS upper level, SG narrow range level, SG wide range level, SG pressure, RWST level, RCS sub cooling, ICCM RCS pressure, core exit TC, charging flow, SI flow cold leg, SI flow vessel injection, RHR flow to RCS, RHR flow to vessel, AFW flow, containment hydrogen, containment pressure narrow, containment pressure wide, containment radiation 1EO-1E8 R/hr), containment sump level, and/or containment level. One or more other instruments that may be checked against respective ranges using the disclosed techniques can include, but are not limited to, RCP seal D/P, RCP seal leakoff flow, RCP LWR bearing water temperature, RCP no. 1 seal outlet temperature, RCP seal injection flow, CST level, cooling water flow, cooling water pressure, IR flux, IR startup rate, RHR pressure, SG PORV controller setpoint, VCT level, NIS power range, NFM lineage power range, NFM log power range, AFW pump disch pressure, RHR HX outlet FCV position setpoint, RHR bypass valve position setpoint, boration flow rate, BAST recirc valve position setpoint, and/or BAST temperature.

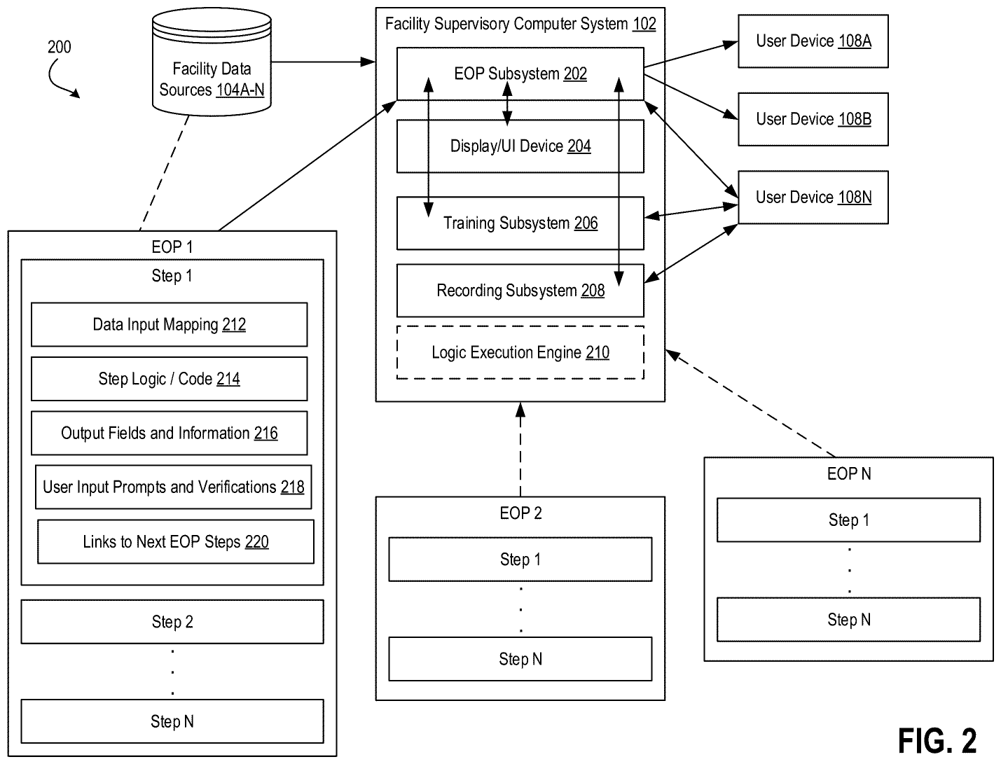

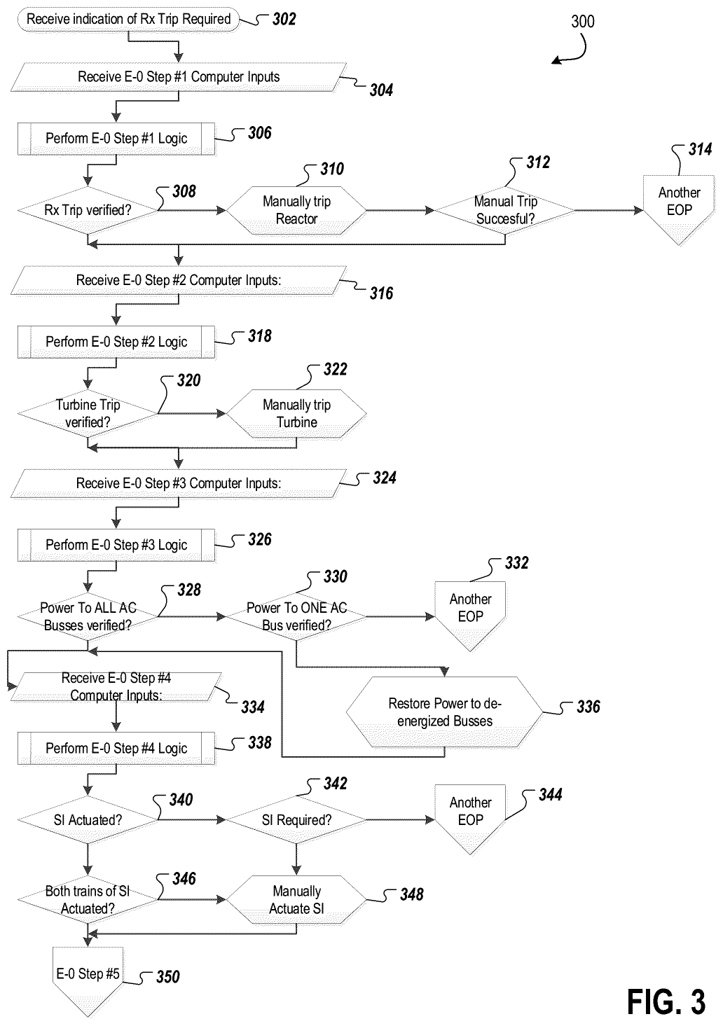

In block C (124), the facility supervisory computer system 102 can perform logic to determine EOP conditions, steps, and/or actions to be taken in response to the event. As described further in FIGS. 2 and 3, the facility supervisory computer system 102 can retrieve computer logic/code from one or more of the facility data sources 104A-N (e.g., a database or other type of data repository) and execute the logic/code to automatically perform one or more steps of an EOP that can be used to mitigate the detected event in the facility.

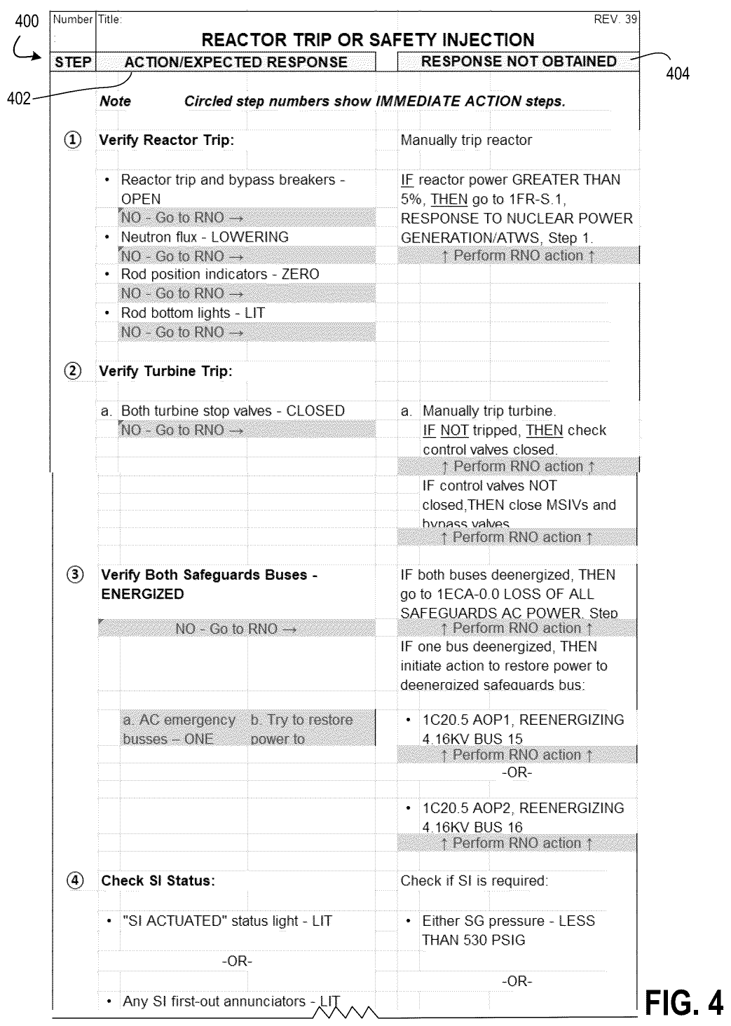

The facility supervisory computer system 102 can also transmit instructions (block A, 120) to one or more of the user devices 108A-N that cause the respective device to present a dashboard with real-time status of the EOP conditions, steps, and/or actions (block D, 126). The user devices 108A-N may also receive data from any of the facility data sources 104A-N, such as parameter values and other sensed data, that can be presented in the dashboard. The dashboard can provide an electronic version of the EOP steps, as described further in reference to at least FIGS. 4 5A, 5B, 6A, 6B, 6C, 9A, 9B, 9C, 9D, 9E, 9F, 9G, 10A, 10B, 10C, and 10D.

Optionally, one or more of the user devices 108A-N may receive user input indicating acknowledgement of and/or actions performed according to the presented EOP conditions, steps, and/or actions (block E, 128).

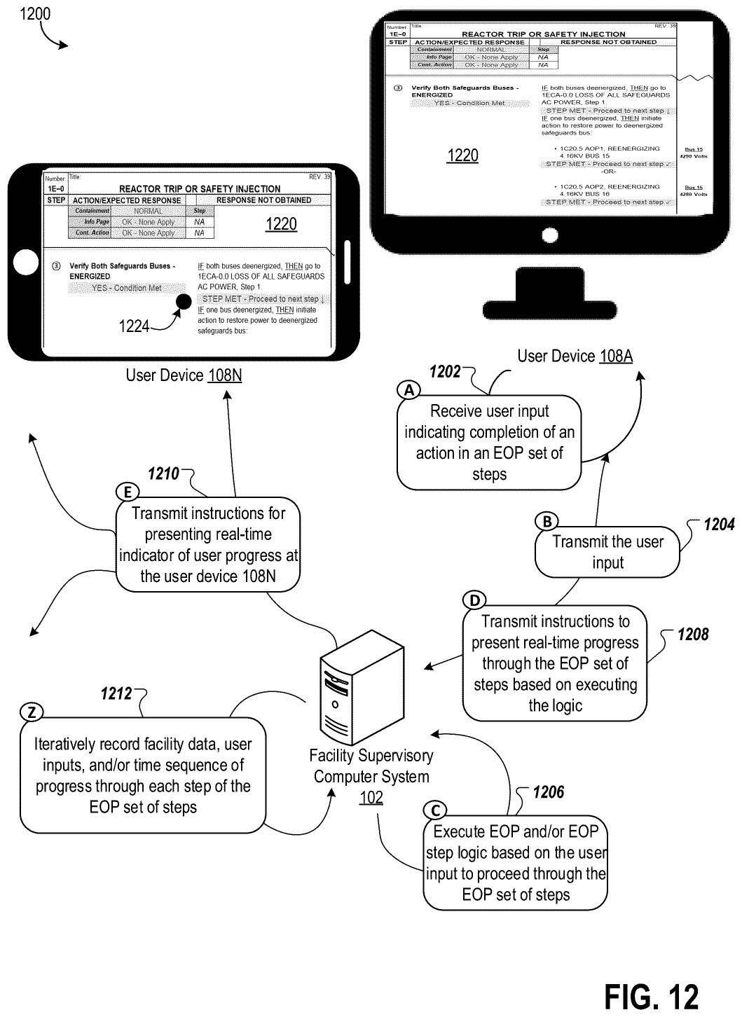

Optionally, one or more of the user devices 108A-N may be used by relevant users in the facility to monitor progress of the EOP conditions, steps, and/or actions (block X, 130). Refer to at least FIG. 12 for further discussion about replicating the dashboard and real-time progress through the EOP steps across multiple user devices.

The user input received in block E (128), can be transmitted back to the facility supervisory computer system 102 (block A, 120), and used to determine whether the EOP conditions, steps, and/or actions are completed and/or the detected event is mitigated (block F, 132).

Based on the determination in block F (132), the facility supervisory computer system 102 can continuously and/or iteratively update information presented in the dashboard (block G, 134). Accordingly, the facility supervisory computer system 102 can transmit instructions to one or more of the user devices 108A-N to replicate the information presented in the dashboard such that the users can monitor the progress as the detected event is mitigated (and/or perform actions according to the EOP steps to mitigate the detected event).

FIG. 2 is a system diagram of components and data objects using the disclosed techniques for providing a facility monitoring response tool to users in the facility. A system 200 can be similar to the system 100 described in FIG. 1. For example, the system 200 can include the facility supervisory computer system 102, the facility data sources 104A-N, and the user devices 108A-N. Any of the user devices 108A-N can include monitoring and/or active participant devices. As described herein, for example, some of the user devices 108A-N can simply receive information and present the information so that respective users can follow along through progress of EOP steps while others of the user devices 108A-N can present the information and receive user input indicating actions, verifications, and/or responses to one or more of the EOP steps.

The facility supervisory computer system 102 can include an EOP subsystem 202, a display/UI device 204, a training subsystem 206, a recording subsystem 208, and/or an optional logic execution engine 210. The EOP subsystem 202 can be configured to execute computer logic/code to present and perform one or more steps in a set of steps for an EOP. The EOP, as described herein, can be selected and implemented in response to detection (e.g. by the facility supervisory computer system 102) of an emergency or event in the facility. As described further below, the EOP subsystem 202 can load one or more EOP 1-N data objects into the EOP subsystem 202, receive facility data from the facility data sources 104A-N, and output such information in a dashboard to the display/UI devices 204 and/or one or more of the user devices 108A-N.

The display/UI device 204 can be any type of display screen, touchscreen, audio, or visual output configured to present an electronic version of the EOP steps and progress through the EOP steps. Sometimes, the display/UI device 204 can be a separate device from the facility supervisory computer system 102.

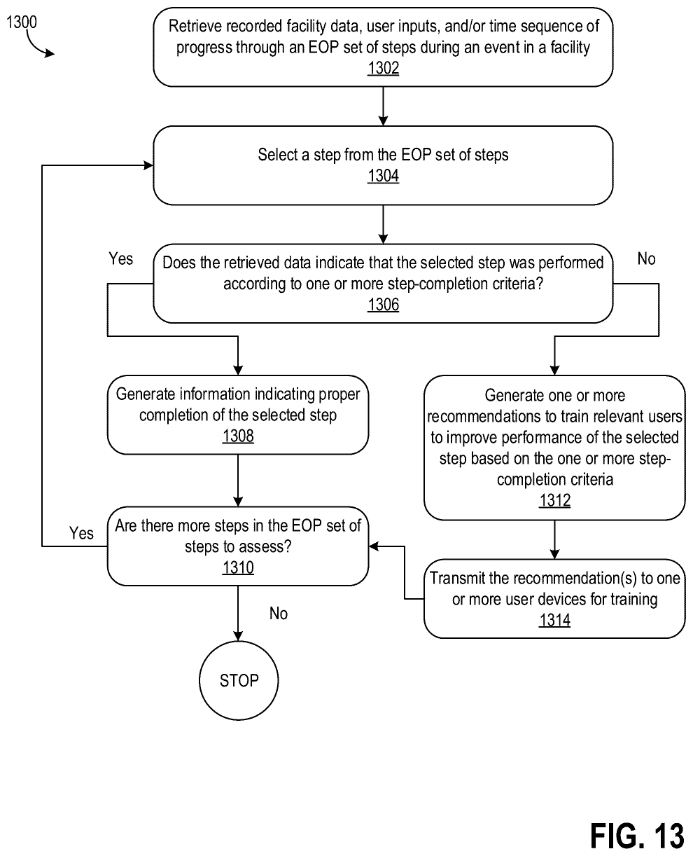

The training subsystem 206 can be configured to determine one or more ways in which performance through the EOP steps can be optimized and/or performed more efficiently. Refer to at least FIG. 13 for further discussion about determining training improvements for the facility.

The recording subsystem 208 can be configured to record or otherwise track progress of the facility through the EOP steps. Data, inputs, and/or time sequence data can be recorded and/or paired with audio, visual, and/or screengrabs that are captured (e.g., automatically, iteratively, at predetermined time intervals) whenever actions are taken and/or EOP steps are performed/processed. Recording can include maintaining timestamps or other timing data indicating how long it may take users to perform manual actions for one or more of the EOP steps. Recording can include maintaining screengrabs, audio, and/or visual recordings of the progress through the EOP steps. Data that is generated by the recording subsystem 208 can be stored by one or more of the facility data sources 104A-N (e.g., in one or more data stores) and/or used by the training subsystem 206 to determine ways in which to improve performance of the EOP steps.

The logic execution engine 210 can be configured to provide a layer of verifying parameters, value ranges, and/or completion of one or more of the EOP steps. For example, the logic execution engine 210 can be designed to automatically perform one or more of the EOP steps and determine when to require a user at one or more of the user devices 108A-N and/or the display/UI device 204 to perform a manual action and/or verification during completion of the EOP steps.

EOPs 1-N can be data objects stored in the facility data sources 104A-N and/or the facility supervisory computer system 102. For example, the EOP 1-N data objects can be stored in an EOP data store. Each of the EOP 1-N data objects can include one or more steps 1-N, which, when executed according to corresponding computer logic/code, can cause the steps 1-N of the respective EOP 1-N to be presented as an electronic version at one or more of the user devices 108A-N. Executing the computer logic/code can also cause the EOP subsystem 202 to automatically perform one or more of the EOP steps 1-N.

Each of the steps 1-N can include data input mapping 212, step logic/code 214, output fields and information 216, user input prompts and verifications 218, and/or links to next (or prior) EOP steps 220. The data input mappings 212 can include rules or other type of logic that can be used by the EOP subsystem 202 to determine how to correlate data received from the facility data sources 104A-N and/or the user devices 108A-N with different types of actions, conditions, human checkpoints, and/or manual actions according to the respective EOP.

The step logic/code 214 can be executed by the EOP subsystem 202 to automatically perform one or more of the EOP steps and/or determine when to require human checkpoints and/or manual actions to complete the EOP steps. For example, the EOP subsystem 202 can execute a program in which the logic/code 214 can be executed. Executing the logic/code 214 can cause the corresponding EOP to be loaded and performed in the EOP subsystem 202. Each of the steps 1-N can include logic/code 214 specific to performing and completing the respective step. The logic/code 214 can include software logic that mimics operations that would be performed by a human operator in traditional scenarios where the human operator works through a paper version of the EOP steps. The logic/code 214 can be executed by the EOP subsystem 202 to retrieve rules associated with completing EOP steps, retrieve data values, and connect/associate the data values with each other (e.g., using the data input mappings 212) to determine whether rules associated with each of the EOP steps 1-n are satisfied (and thus an EOP step is successfully completed).

The output fields and information 216 can include rules and other logic/code that can be executed by the EOP subsystem 202 to generate dashboards and electronic versions of the EOPs 1-N to be presented at the display/UI device 204 and/or the user devices 108A-N. The output fields and information 216 can include text objects, visual objects, and other output fields that can be shown/displayed at the display/UI device 204 and/or the user devices 108A-N so that an electronic version of the respective EOP mimics appearance of a traditional paper version of the respective EOP.

The user input prompts and verifications 218 can include rules and/or logic for execution by the EOP subsystem 202 to determine when to require user input, checkpoints, manual actions, and/or verifications from one or more of the user devices 108A-N and/or the display/UI device 204. The user input prompts and verifications 218 can also include the prompts that may be presented at the user devices 108A-N and/or the display/UI device 204 when user intervention is required for one or more of the EOP steps 1-N.

The links to the next EOP steps 220 can include selectable forward and back links that can be presented and used at the user devices 108A-N and/or the display/UI device 204 to provide navigation between the EOP steps being performed. Sometimes, for example, the links 220 can be automatically presented and/or followed by the EOP subsystem 202 in response to determining that one or more of the EOP steps 1-N have been successfully completed. As another example, the links 220 can be presented in the dashboards described herein at the display/UI device 204 and/or the user devices 108A-N, which can then be selected by a relevant user to navigate between one or more of the EOP steps 1-N.

FIG. 3 is a flowchart of an illustrative process 300 for executing computer logic to perform an EOP set of steps that can mitigate a detected event in a facility. The process 300 can be performed by components described in FIG. 2. For example, the process 300 can be performed by the EOP subsystem 202. The process 300 can also be performed by any other type of computing system described herein (e.g., the facility supervisory computer system 102).

The process 300 can be performed in response to the EOP subsystem 202 loading and executing computer logic/code 214 for each of steps 1-N in an EOP that is triggered and performed in response to detecting an emergency/event in the facility. The EOP subsystem 202 can execute a configuration file (e.g., the computer logic/code 214) that can be used to identify what steps, logic, and/or inputs can be used for performing/executing each EOP step. The EOP subsystem 202 can also use the data input mapping 212 to define what data is used and how the data is processed to perform steps (e.g., sub-steps) within each of the EOP steps. For illustrative purposes, the process 300 is described from the perspective of an EOP subsystem.

Referring to the illustrative process 300 in FIG. 3, the EOP subsystem can receive an indication of an Rx trip (block 302). This indication may be received from one or more of the facility data sources 104A-N. Receiving the indication can be required to cause the EOP subsystem to execute the logic/code for performing each step in an EOP that can be used to address the Rx trip event. In response to receiving the indication, the EOP subsystem can identify an EOP, such as E-0, that may be designated for mitigating and responding to the Rx trip event. Once the EOP is identified, the EOP subsystem can retrieve logic/code associated with each step of the identified EOP, and execute the logic/code to progress through the EOP.

Accordingly, in block 304, the EOP subsystem can receive E-0 step 1 computer inputs. The inputs can be received from one or more of the facility data sources 104A-N. The inputs can be received from one or more of the user devices 108A-N and/or the facility supervisory computer system 102. For example, computer inputs may include control rod position and/or reactor power level.

In block 306, the EOP subsystem can perform E-0 step 1 logic/code. As described further in response to FIG. 2, the EOP subsystem can execute logic/code associated with the specific step currently being performed in the EOP. Performing this logic can include mapping the received computer inputs with conditions, value ranges, parameters, etc. associated with step 1 in the EOP. As an illustrative example, executing the logic in block 306 can include mapping the inputs received in block 304 about the reactor trip, neutron flux, rod position indications, and/or rod bottom lights to Yes or No conditions. This mapping can be performed automatically by the EOP subsystem. Such mappings can then be manually checked/verified by a relevant user, such as in block 308. If the user disagrees with any of the mappings, the EOP subsystem may generate instructions that cause the user to perform a manual action or actions to complete the EOP step.

In response to performing the logic in block 306, the EOP subsystem can determine whether the Rx trip was verified (block 308) (e.g., automatically by a computer system described herein, manually by a relevant user). Sometimes, block 306 can require the user to check and verify the Rx trip, or any of the mappings described above that are determined in response to performing block 304. If the trip is not verified, the EOP subsystem can generate and return instructions that cause a relevant user to manually trip the reactor (block 310). The EOP subsystem can continue to receive data from the facility data sources 104A-N and/or the user devices 108A-N, which can then be used to determine whether the manual trip was successful (block 312). If the manual trip was unsuccessful, the EOP subsystem can generate and return output indicating an entry into another EOP is required (block 314). If the manual trip was successful, the EOP subsystem can proceed to block 316 to direct performance of a next sequential EOP step.

If the Rx trip was verified in block 308, the EOP subsystem can proceed to block 316.

In block 316, the EOP subsystem can receive E-0 step 2 computer inputs. In other words, the EOP subsystem proceeds to a next step in the EOP. The EOP subsystem can retrieve the data input mapping 212 and the step logic/code 214 associated with the next step (step 2), which can be executed and used to process the computer inputs received in block 316.

The EOP subsystem can perform the E-0 step 2 logic in block 318.

In response to performing the logic, the EOP subsystem can determine whether a turbine trip has been verified in block 320. If the turbine trip was not verified, the EOP subsystem can generate and return instructions that cause the relevant user to manually trip the turbine (322). The EOP subsystem can then return to block 320.

If the turbine trip is verified in block 320, the EOP subsystem proceeds to block 324, in which the EOP subsystem receives E-0 step 3 computer inputs. Refer to blocks 304 and 316 for further discussion.

The EOP subsystem can perform E-0 step 3 logic in block 326. Refer to blocks 306 and 318 for further discussion about executing step-based logic.

In response to executing the step 3 logic, the EOP subsystem can determine whether power to all AC busses has been verified (block 328). If the power to all busses has not been verified, the EOP subsystem can determine whether power to one AC bus has been verified (block 330). If the power to one AC bus has not been verified, the EOP subsystem can direct entry into another EOP. If, on the other hand, the power to one AC bus is verified in block 330, the EOP subsystem can generate and return instructions that cause the relevant user to restore power to de-energized busses (block 336). The EOP subsystem can then return to block 328.

In block 328, if the power to all the AC busses has been verified, the EOP subsystem can proceed to block 334, in which the EOP subsystem can receive E-0 step 4 computer inputs. Refer to at least block 324 for further discussion.

The EOP subsystem can perform E-0 step 4 logic/code in block 338. Refer to at least block 326 for further discussion.

In response to executing the step 4 logic, the EOP subsystem can determine whether an SI has been actuated in block 340. If the SI has not been actuated, the EOP subsystem can determine whether the SI is required (block 342). If the SI is not required, the EOP subsystem can direct entry into another EOP, such as a reactor trip recovery EOP (block 344).

In block 342, if the SI is required, the EOP subsystem can generate and return instructions that cause the relevant user to manually actuate the SI in block 348. The EOP subsystem can then proceed to block 346, described below.

In block 340, if the SI is actuated, the EOP subsystem can determine whether both trains of the SI have been actuated in block 346. If both trains have been activated, the EOP subsystem can proceed to block 350, in which the EOP subsystem generated and directs E-0 step 5. If both trains have not been activated, the EOP subsystem can proceed to block 348, in which the user is instructed to manually actuate the train(s) that has not been activated.

Although the process 300 is shown with respect to the EOP subsystem completing 4 steps of an EOP, the process 300 can similarly be performed to complete any quantity of steps associated with any EOP. The quantity of steps can be determined based on the EOP that is selected and used to address a particular type of emergency or event detected in the facility. For example, the Rx trip event may be associated with an EOP that has a plurality of steps (e.g., dozens) while another event may be associated with an EOP having fewer steps. The blocks in the process 300 can therefore be performed by the EOP subsystem to define and determine what data inputs are received, what logic is applied, and what conditions are checked to automatically perform and/or verify completion of each EOP step. Any of the data inputs, logic, and/or conditions can be represented digitally in data objects, as described in reference to FIG. 2.

The process 300 and similar processes can be performed to cure one or more inefficiencies that may result from using traditional paper-based versions of the EOP. For example, “Reset SI” action can appear in EOPs approximately 20 or more times. Using the disclosed technology, the EOP subsystem can determine if and when that action is completed (based on analyzing and mapping data received from the facility data sources 104A-N) and only direct the user to complete the action if the action is not complete/is needed. As another example, with regards to SI alignment verification, the process 300 can be used to prioritize addressing exceptions before verifying already satisfied alignments, which can result in improving and reducing an amount of time that the user may work through the corresponding EOP step(s). Moreover, the EOP subsystem can automatically select correct EAL and/or release status, which can sometimes be backed up manually by a Shift Manager (SM) and/or an Emergency Director (ED). The process 300 can also include PRA recovery steps, which can be recognized by the EOP subsystem and prompted to the relevant user only if required. The PRA recovery steps can be determined by a probabilistic risk assessment computer model.

As described herein, the process 300 can also provide Time Critical Operator Action (TCOA) improvements. For example, the EOP subsystem can automatically recognize when action is needed and can direct completion of such action by the relevant user at an earliest possible moment, then confirm that the action has been met. Such actions can include, but are not limited to, RCP trip criteria, isolating AFW to a faulted or ruptured SG, actions to prevent overfill on a ruptured SG (which can sometimes be approximately 45 steps to navigate through only 6 or 7 true actions that may be required), re-energize safety related bus (e.g., by recognizing and directing a most likely and efficient success path), and/or internal flooding (e.g., pump/valve alignment, flow, FP sprinkler flow). The process 300 can further be performed to identify when SI termination criteria has been met. Often in traditional implementations, the relevant user may recognize this late, which can complicate recovery plans. The process 300 can also be performed to provide appropriate RCS temperature control following certain types of events (e.g., MSLB). The EOP subsystem can, for example, recognize heat up and/or cool down and only direct the specific action needed to address such a detected condition.

FIG. 4 illustrates an example electronic version of an EOP 400 for mitigating a detected event in a facility. The electronic version of the EOP 400 can include a visual presentation or display of the EOP, which mimics and/or is otherwise similar in style to a traditional paper version of the EOP. The electronic version of the EOP 400 can therefore be stylized and formatted similarly to the paper version, including with respect to colors, font, spacing, steps, columns, etc. Although EOPs may vary based on facility, electronic versions of the EOPs can be designed to mimic or otherwise replicate the corresponding paper versions.

As shown in FIG. 4, the electronic version of the EOP 400 is for PWRs and has a 2-column format. Electronic versions of EOPs for BWRs can be similarly stylized with a flowchart (rather than columns). Here, the electronic version of the EOP 400 is used in response to an event such as a reactor trip or a safety injection. This illustrative EOP is identified as 1E-0, which can be used for entering an EOP network. Recovery procedures can be EOPs that direct recovery actions after the event has been mitigated. The electronic version of the EOP 400 includes an Action/Expected Response column 402 and a Response Not Obtained column 404. When the electronic version of the EOP 400 is presented at a display or user device, a relevant user can work through one or more of the steps in the column 402. The steps in column 402 can be performed to determine whether the reactor tripped and whether certain conditions have been met to ensure safety and mitigation of such an event in the facility. Sometimes, one or more of the steps in the column 402 can be automatically performed by the computer system as described herein. The computer system can also determine when and which of the steps should be checked and/or verified by the user.

As shown in the column 402, if any of the conditions in steps 1-4 are determined to be a NO, then the user is prompted to proceed to perform manual actions shown in the column 404. As an illustrative example, as shown with regards to step 1, if any of the conditions for verifying the reactor trip are determined to be a NO, the user is prompted to manually trip the reactor, as shown in the column 404. If the reactor is unable to be manually tripped, the user may be prompted to proceed to a next procedure, such as IFR-S.1. If the reactor is successfully manually tripped, the user is prompted to proceed to reviewing/verifying step 2 (verify turbine trip) and potentially performing one or more manual actions to trip the turbine.

As described herein, the computer system, such as the EOP subsystem 202, can be configured to automatically perform logic corresponding to each step to make the condition determinations shown in the column 402. Executing/performing the logic can include receiving facility data from a variety of sources, mapping the facility data to the conditions, and/or applying rules to the mappings to determine whether conditions are satisfied and/or whether manual action is required by the relevant user(s).

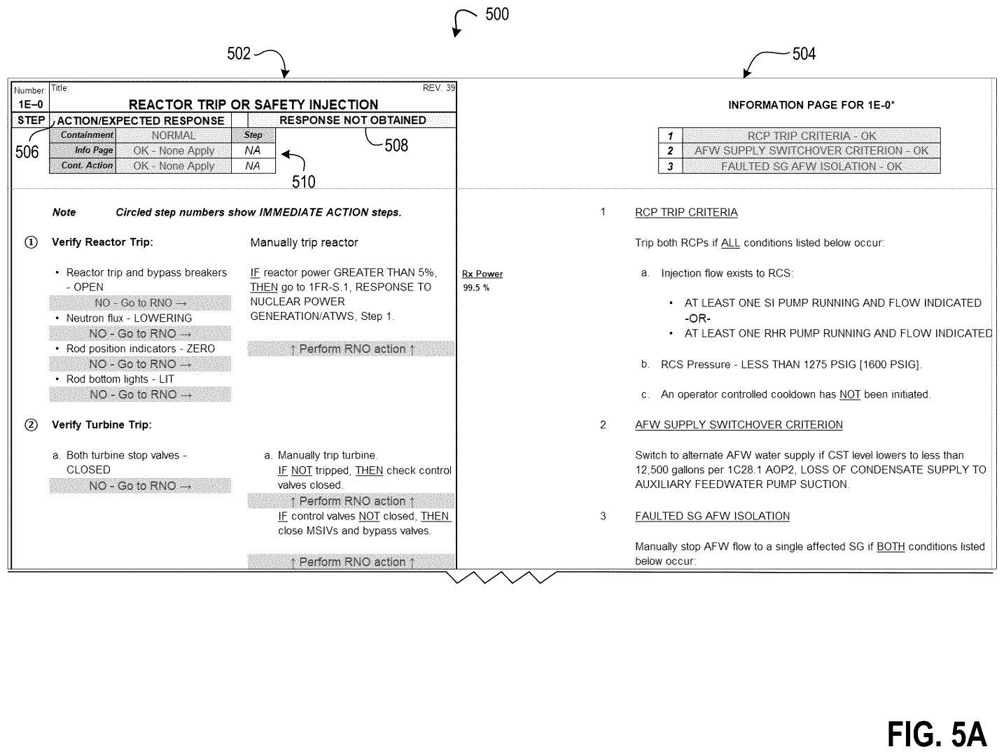

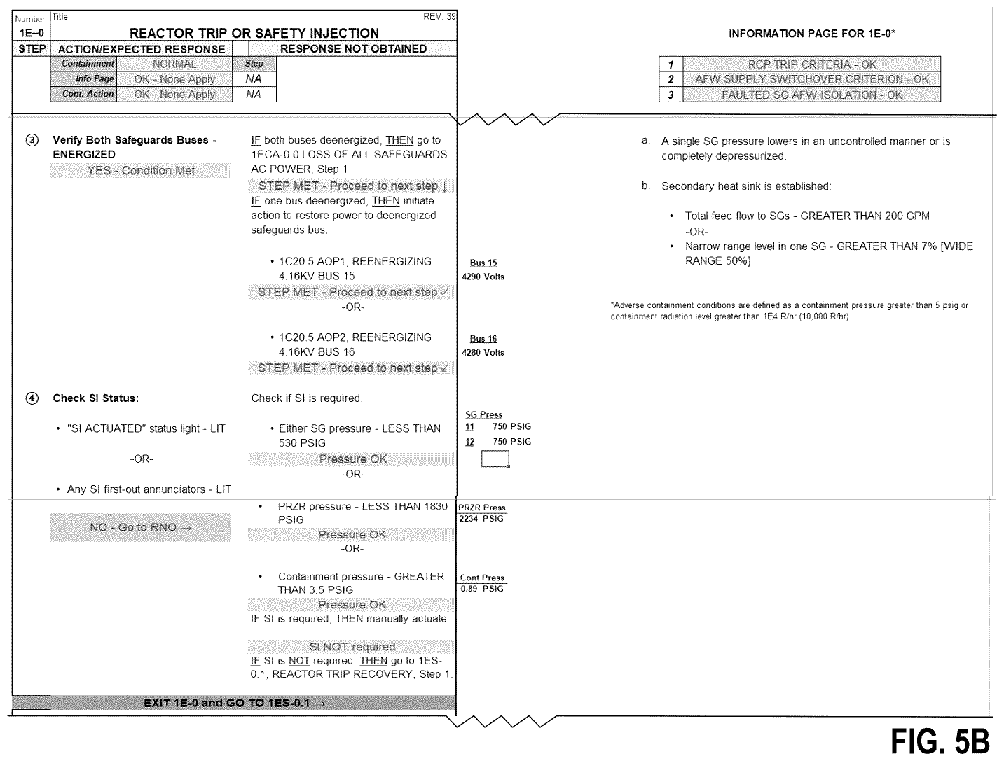

FIGS. 5A and 5B5C illustrate another example electronic version of an EOP 500 for mitigating a detected event in a facility. As shown in the FIGS. 5A and 5B, the electronic version of the EOP 500 can include an EOP 502 and an information page 504. The EOP 502 and the information page 504 can be shown alongside each other and presented at one or more devices/displays described herein in order to provide relevant users with additional information they may need to work through EOP steps shown in the EOP 502.

The EOP 502 can include columns 506 and 508, which are similar or the same as the columns 402 and 404 shown and described in FIG. 4. The column 506 includes steps associated with the EOP that may be automatically performed by the computer system described herein and/or verified/performed by the relevant user(s). The column 508 can include manual actions that may be required to be performed by the relevant user(s), based on step-based logic that is performed by the computer system for each of the steps displayed in the column 506. Information presented in the EOP 502 can be applicable at all times that the relevant user(s) is addressing the detected event in the facility. The relevant user(s) may also watch the conditions in the EOP 502 while they work through any part of the EOP procedure to see whether any of such conditions change and therefore need to be addressed in real-time.

Using the disclosed technology, the conditions in the column 506 can be automatically determined and/or updated by the computer system, whereas traditionally, the relevant user(s) using a paper version of the EOP would have to manually manage and check the conditions while also working through the EOP steps to combat the detected event. Accordingly, the disclosed technology can reduce, mitigate, or otherwise end human error that otherwise may occur when the traditional paper version of the EOP is used to respond to the detected event. The computer system can monitor the conditions identified in the steps displayed in the column 506 and flag any of the conditions that need to be checked by the relevant user(s). As a result, the disclosed technology can provide built-in human checkpoints, where the relevant user(s) can be required to make decisions and/or verify decisions/determinations to ensure safety of operations in the facility. The checkpoints can require the relevant user(s) to stop, review data collected/received from one or more facility data sources, and confirm any of the recommended actions, determinations, or conditions made by the computer system. Such human verifications can allow automation or other computer-based determinations to be validated. Sometimes, the checkpoints may be used to verify certain high-risk and/or high-safety issues or conditions in the facility (e.g., transitions between steps, transitions between EOPs).

In some implementations, graphical indicia can be used and presented in the electronic version of the EOP 500 to indicate actions to be performed by the relevant user(s). For example, triangles can be shown next to one or more steps in the column 506 that always require human checking/verification, regardless of how far ahead the computer system and/or the user made it through the EOP steps.

The human checks/verification can include a continuous action step. Sometimes, the required continuous action step can be presented at a top of the electronic version of the EOP 500, such as in a table 510. The required continuous action step can be presented in an indicia such as a color or pattern that draws the user's attention. For example, the required continuous action step can be presented in red in the table 510. When the user selects the required continuous action step in the table 510, the user can be directed to the corresponding step in the electronic version of the EOP 500. For example, the user selection can cause the computer system to jump down in the EOP 502 to present the corresponding step and associated conditions and/or actions to be taken.

As shown in FIGS. 5A and 5B, as the user scrolls through the EOP 502, the information page 504 may also be automatically scrolled (refer to FIGS. 5A and 5B). The user can continue to scroll through the EOP 502, even if no more information is shown in the information page 504. The relevant user(s) may still perform manual actions to control equipment and components in the facility. However, the electronic version of the EOP 500 can present, such as in the column 504, recommended actions that the user can validate and take to control the equipment and the components and thus mitigate the event/emergency in the facility.

In some implementations, completion and/or conditions met during one EOP can cause the computer system to determine that another EOP has to be performed. As shown in FIG. 5B, the computer system determined that particular conditions have been met and/or verified that requires completing the EOP 1E-0 and performing EOP 1ES-0.1. The EOP 1ES-0.1 can be presented as another electronic version of the EOP in the dashboards described herein. In some implementations, steps for the EOP 1ES-0.1 can be presented in the EOP 502 so that the relevant user can seamlessly transition between the prior EOP and the next EOP to efficiently mitigate the detected event/emergency in the facility.

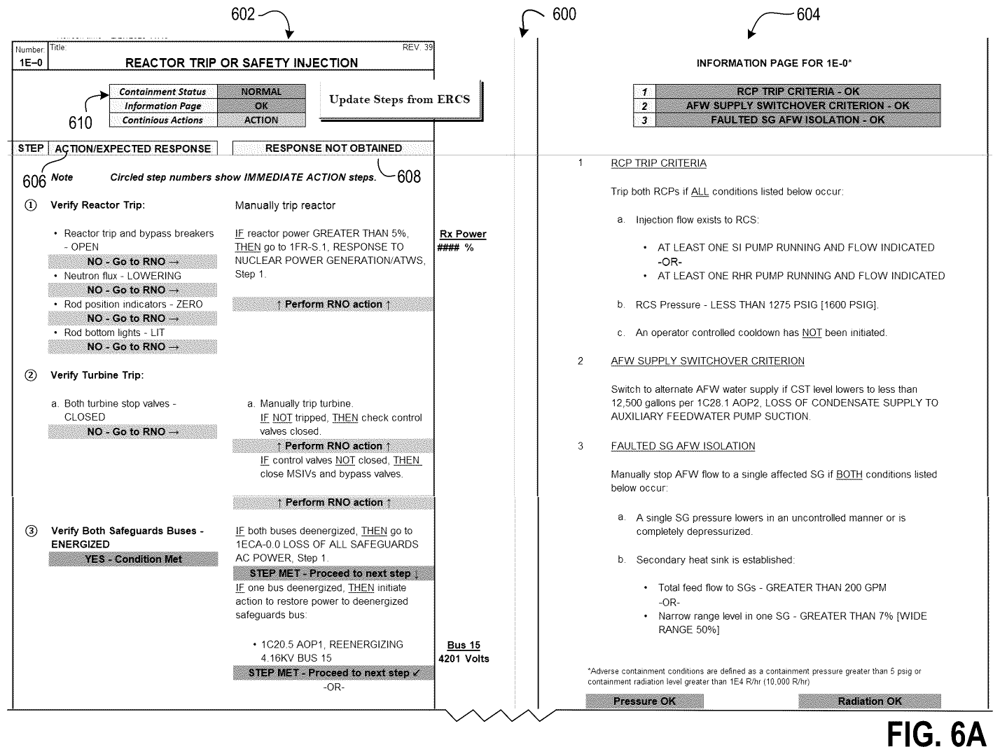

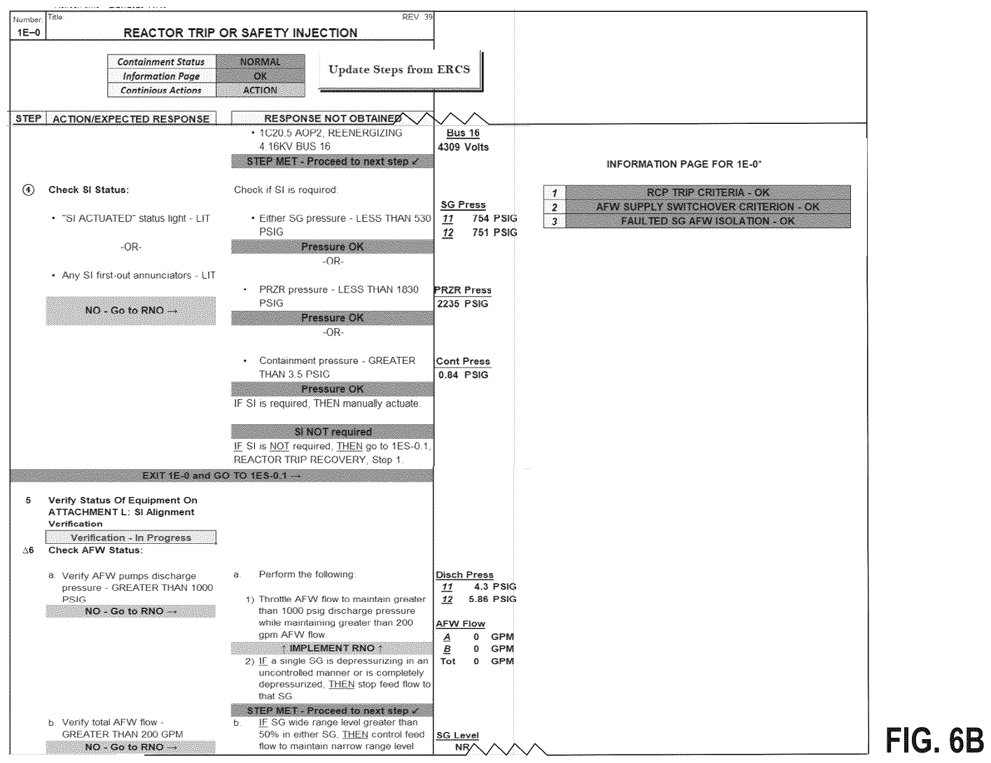

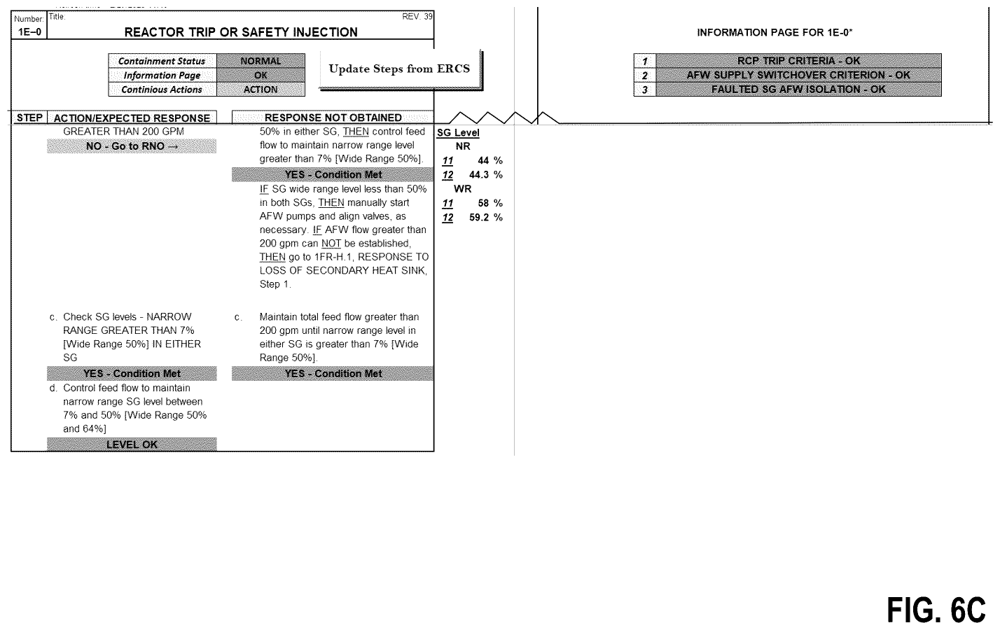

FIGS. 6A, 6B, and 6C illustrate another example electronic version of an EOP 600 for mitigating a detected event in a facility. Similar to the electronic version of the EOP 500 described in reference to FIGS. 5A and 5B, the electronic version of the EOP 500 can include an EOP 602 shown alongside an information page 604. The electronic version of the EOP 600 can also include, for the EOP 602, columns 606 and 608, as well as a status table 610. Refer to FIGS. 5A and 5B for further discussion about these components.

As described throughout this disclosure, computer logic/code necessary to complete each EOP step can cause the disclosed computer system to automatically update the step without user input. A window or other output field below each step can display a status of the step and has background color to guide the user to perform the appropriate action. In the example of FIGS. 6A, 6B, and 6C, an orange background color can be used to show that a No condition is identified and/or the user has to perform a manual action. A blue background color can be used to show that a Yes condition is identified and/or the user does not have to perform some manual action.

As shown and described herein, the table 610 can indicate what continuous action steps may be needed and/or when such steps must be performed by a relevant user. Moreover, the table 610 may always be presented in the electronic version of the EOP 600, regardless of how much and when the user scrolls through the EOP 602 and/or the information page 604.

Traditionally, a paper version of the EOP 602 may be laminate, which allows the user to draw directly on the paper version of the EOP 602 and erase any of their drawings after an event is mitigated and/or the user completes the EOP 602. When the user draws on the paper version of the EOP 602, the user can draw arrows to show progress through one or more of the steps and/or manual actions. The user can also highlight or color one or more steps and/or actions on the paper version of the EOP 602 to indicate Yes or No conditions or otherwise to mark the user's progress through the EOP 602.

Similar styling, coloring, arrows, highlighting, and other indicia can be used with the electronic version of the EOP 600 to indicate progress through the EOP 602 and thus make it easy for relevant users to transition between using the paper version and the electronic version of the EOP 602. In the example of FIGS. 6A, 6B, and 6C, orange coloring or highlighting can be used to indicate that a No condition was identified and/or action by the user is required. Blue coloring or highlighting can be used to indicate that a Yes condition was identified (e.g., a step or other condition was satisfied) and that no user action is required. Arrows can be used to show which direction or what next step or action the user ought to go to.

As an illustrative example, as shown in FIG. 6B, step 5 can require the user to verify a status of equipment on attachment L: SI alignment verification. Because the user may currently be performing this step, a visual indicator can be displayed beneath step 5 in yellow and indicating “Verification—In Progress.” Step 6 can have a triangle displayed next to it, which indicates that manual action and verification is always required, as described above. Sub-step a of step 6 can be automatically performed by the computer system described herein by analyzing and mapping facility data corresponding to AFW pumps discharge pressure measurements. Here, the computer system determines that the PSIG is not greater than 1,000, so this outcome is highlighted or colored orange and an arrow and prompt indicates that the user must perform step a(1) in the RNO column 608. The user can then proceed to a(2) in the same column 608. As shown in FIG. 6B, the computer system can determine that the step 6(a) in column 606 has been met and that the user should proceed to the next step (as shown by an arrow near the blue highlighted/colored text), which is step 6(b).

In some implementations, the electronic version of the EOP 600 can include one or more selectable options/buttons that allow the user to manually update and/or change any of the steps or information presented/determined using the disclosed technology. The user may also select or right click on any of the values presented in the electronic version of the EOP to see additional trends, graphs, or other real-time information that may be collected by components in the facility and other data sources in the facility. Although such additional information can be accessible from the electronic version of the EOP 600, the electronic version of the EOP 600 itself may present less information in order to remain simple, user-friendly, easy and efficient to navigate, and most similar to the traditional paper version of the EOP 602.

As described herein, the electronic version of the EOP 600 provides a dashboard display that can include important information relative to EOP response including Containment Status, Information (foldout) page items, and Continuous Actions. An applicable Emergency Action Level and Release Status and also be presented in the dashboard display. Important or other relevant facility parameters, value, and trend can be displayed in a location relative to, and convenient for, completion of an applicable step.

The electronic version of the EOP 600 can also include options for the user to manually mark steps complete or in-progress for data tracking and timing purposes, options to flag certain steps or decision points (such as EOP transitions) as requiring independent confirmation/verification by an operator using only the paper-based EOP and control board indications, a link to background/basis information for each EOP step, a forward and backward hyperlink to other applicable EOPs in the location that may be needed (which may include a “return to step in effect” link), an EOP step completion tracking tool (running in the background) which times and tracks completion of EOP steps requiring manual action, and/or an EOP step error tracking tool (running in the background) which can identify EOP steps not completed correctly, logs them, and prompts relevant users to recover the action (e.g. a step directs stopping FW flow but the executed computer logic identifies it wasn't done based on remaining flow and provides a pop-up window to re-perform the action or provide contingencies). The electronic version of the EOP 600 can also include an expected facility alignment tool which can identify off-normal alignments, prioritize them, and provide guidance to perform manual action to establish correct alignment (similar to 1E-0 Attachment L). The electronic version of the EOP 600 can include an “additional contingency actions” link in the “Response Not Obtained (RNO)” column 608 to provide direction beyond what may already be listed in the RNO column. The electronic version of the EOP 600 can include selectable options to allow the user to jump back to a step requiring “Continuous Action” when certain condition(s) is met.

The electronic version of the EOP 600 can include an option to view EOP progress in real-time from any other workstation or device either from a directly connect device or station or over a LAN or other type of network. This can be particularly beneficial for emergency response facilities during accident or drill conditions (EOF, TSC, etc). This feature may also include a free-form method of communication between emergency centers and a control room similar to a chat feature to eliminate or reduce the need for voice communications over phones or radios.

The electronic version of the EOP 600 can include one or more options to provide communicate (two-way) through the dashboard to operators outside of the control room to perform any required EOP actions. This can also include an ability for outplant operators to mark EOP steps complete, in progress etc. The electronic version of the EOP 600 can also include a free-form method of communication similar to a chat feature to eliminate or reduce a need for voice communications over phones or radios when responding to the detected event in the facility. The electronic version of the EOP 600 can include one or more links to an applicable EOP setpoint calculation that may be useful to an end user (e.g., for background information). The electronic version of the EOP 600 can also display Critical Safety Function Status Tree (CSFST) information directly on the dashboard to facility case of communication of information to the relevant users. The electronic version of the EOP 600 can also include one or more hyperlinks to ERCS system displays that may be useful for implementation or decision-making performed by the computer system or the relevant user at a particular EOP step.

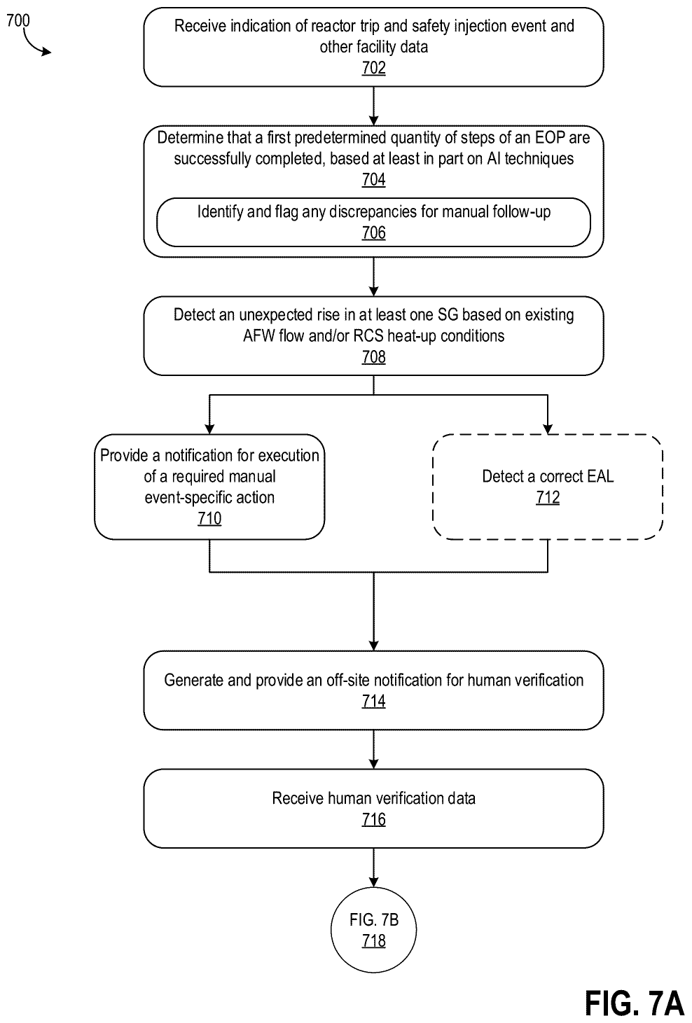

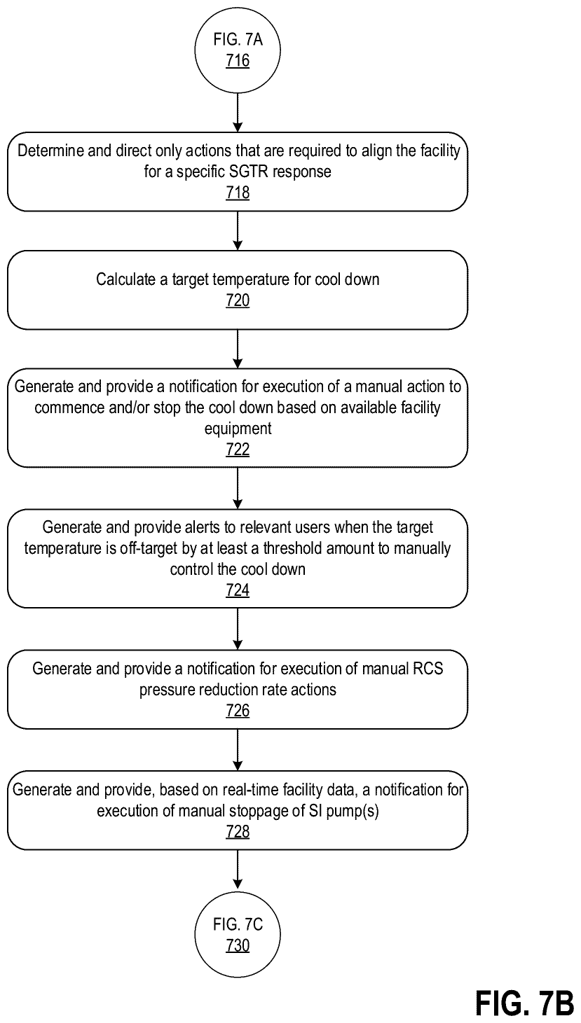

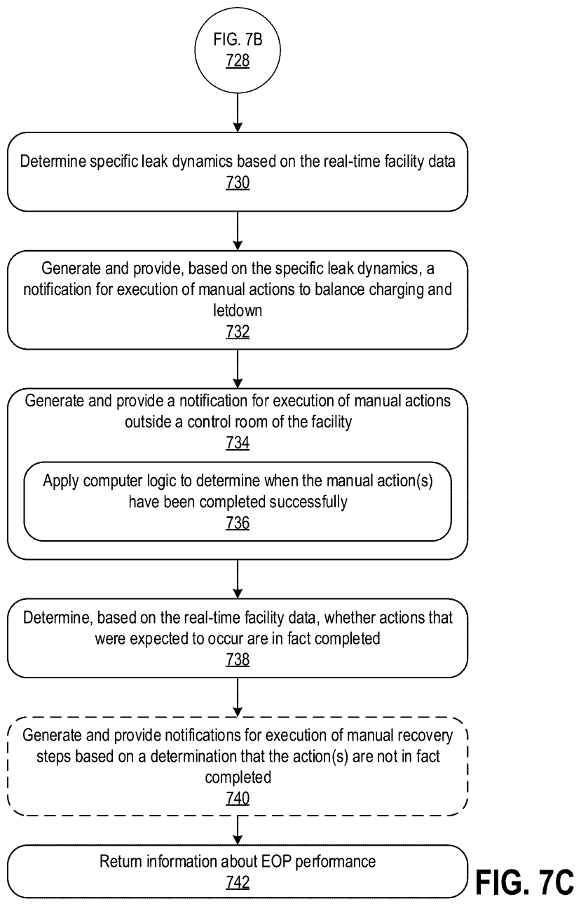

FIGS. 7A, 7B, and 7C is a flowchart of an illustrative process 700 for mitigating an SG Tube Rupture (SGTR) that occurs at a PWR using the disclosed techniques. A typical PWR can require manual operator actions to isolate the SGTR and stop a primary to secondary leakage in the PWR. Such actions may be time critical (TCOAs) and typically can include (in order): isolating AFW to the ruptured SG, cooling down an RCS, depressurizing the RCS, stopping SI pumps, and balancing charging and letdown. All these actions may typically be completed within 30 minutes to prevent SG overfill and associated off-site release of radioactivity. Minimal margins may be available using a traditional paper-based version of the PWR EOPs. A PWR EOP to address this event, for example, may have approximately 40 EOP steps, that must be communicated and completed before the 5 required actions listed above are completed. The process 700 described herein can be performed to efficiently and accurately work through the EOP steps so that the 5 required manual actions can be performed to mitigate the detected event.

The process 700 can be performed by the facility supervisory computer system 102 described herein. More particularly, the process 700 can be performed by the EOP subsystem 202 described herein. The process 700 can also be performed by any other computing system, computing device, cloud-based computing system, and/or network of computing devices. For illustrative purposes, the process 700 is described from a perspective of a computing system.

Referring to the process 700 in FIGS. 7A, 7B, and 7C, the computing system can receive an indication of a reactor trip and safety injection event in block 702. In block 702, the computing system may also receive other facility data described throughout this disclosure (e.g., parameters, ranges, sensed values of one or more components/equipment in the facility).

The computing system can determine, in block 704, that a first predetermined quantity of steps of an EOP are successfully completed, based at least in part on executing computer logic and/or algorithms described herein. For example, the computing system can implement one or more algorithms to process the received data in block 702 and determine whether the first predetermined quantity of steps are actually completed. The computing system may also identify and flag any discrepancies for manual follow-up (block 706). For example, if the computing system identifies that less than all of the steps are successfully completed, the computing system may flag the steps that are not actually completed and present a notification at a user device of a relevant user to check whether the flagged steps are actually completed and if not, then complete such steps.

As an illustrative example of blocks 704 and 706, a first 4 steps of EOP E-0 can be detected as having successfully been completed. These 4 steps can include verifying the Rx trip, a turbine trip, safeguard of busses, and that an SI is actuated. Any discrepancies in these 4 steps can be flagged for operator manual follow-up.

In block 708, the computing system can detect an unexpected rise in at least one SG based on existing AFW flow and/or RCS heat-up conditions. The AFW flow and/or RCS heat-up conditions can be part of the facility data that is received in block 702. This can be an event-specific required action.

The computing system can then perform blocks 710 and 712. The blocks 710 and 712 can be performed simultaneously. Sometimes, the computing system can perform one of the blocks 710 and 712. The computing system can perform one of the blocks 710 and 712 before the other. Sometimes, the blocks 710 and 712 can be performed in a background as the process 700 is performed to implement the EOP steps. In some implementations, block 712 can be optionally performed.

The computing system can provide a notification for execution of a required manual event-specific action in block 710. Sometimes, the computing system can automatically rule out other events, concurrent or otherwise.

The computing system may automatically detect a correct EAL in block 712.

Based on detecting the correct EAL, the computing system can generate and provide an off-site notification for human verification (block 714).

The computing system can receive human verification data in block 716. Such data can be user input received at user devices of relevant users that receive the notification for human verification. The user can provide user input such as a classification/notification via a button push or other type of input at their respective device.

In block 718, the computing system can determine and direct only actions that are required to align the facility for a specific SGTR response. For example, such actions can include resetting the SI, isolating flow from the SG, and/or detecting that instrument air is not lost. The actions can include event-specific required actions.

The computing system can calculate a target temperature for cool down in block 720.

The computing system can generate and provide a notification for execution of a manual action to commence and/or stop the cool down based on available facility equipment (block 722). For example, the computing system can direct steam dump, Steam Generator Power Operated Relief Valve (SG PORV), or one or more other event-specific required actions.

The computing system may also generate and provide alerts to relevant users when the target temperature is off-target by at least a threshold amount to manually control the cool down (block 724).

In block 726, the computing system can generate and provide a notification for execution of manual RCS pressure reduction rate actions. The computing system can also provide instructions or a method for directing the RCS pressure reduction rate based on subcooling. This action may overlap with the cool down action to be more efficient. The notification can provide another event-specific required action.

The computing system can also generate and provide, based on real-time facility data (e.g., as described in reference to block 702), a notification for execution of manual stoppage of one or more SI pumps (block 728). This can be another event-specific required action.

In block 720, the computing system can determine specific leak dynamics based on the real-time facility data.

The computing system can also generate and provide, based on the specific leak dynamics, a notification for execution of manual actions to balance charging and letdown (block 732). This can be another event-specific required action.

The computing system can generate and provide a notification for execution of manual actions outside a control room of the facility in block 734. The manual actions can include securing turbine building (TB) roof exhausters without a need for voice communication. For example, the computing system can apply one or more computer logic and/or algorithms to determine when the manual action(s) has been completed successfully (block 736).

The computing system can determine, based on the real-time facility data, whether actions that were expected to occur are in fact completed in block 738. Actions may not in fact be completed when the action is signed as complete but the computing system (or another computer system) indicates that it has not actually been completed.

The computing system can optionally generate and provide notifications for execution of manual recovery steps based on a determination that the action(s) are not in fact completed (block 740).

In block 742, the computing system can return information about EOP performance. The returned information can include timing information about completion of the different event-specific actions. The returned information can include recordings made by the computing system that indicate actions that were taken and overall performance of the EOP by various relevant users in the facility. The returned information can also include various decisions that were made by the computing system in the process 700 and/or facility data or other real-time data (e.g., sensor data). The returned information can include user responses to the decisions made by the computing system, such as human verifications and/or manual controls that are made by the user in response to output from the computing system. The returned information can include any other information that may be used for training purposes described throughout this disclosure.

The process 700 can be used to determine and direct event-specific actions, which may be required to respond to a specific event. As a result, in the illustrative example of the process 700, only 6 actions may be required instead of 40 actions that otherwise would be performed when using a traditional paper-based EOP. Verification of expected automatic plant responses can also be performed, and can be accomplished independent of user response to the specific event. Crew operators and other relevant users may no longer be required to perform verification of expected responses. Instead, a prioritized list of exceptions can be identified for user follow-up based on when such exceptions are required (e.g., a CI valve fails to close). Moreover, using the process 700, three-way communications are greatly reduced and in some cases can be removed all together. For example, action steps of E-0, Att. L can be automatically directed to a Reactor Operator's (RO) device. Continuous action steps can be constantly monitored and/or relevant users can be alerted if action is required.

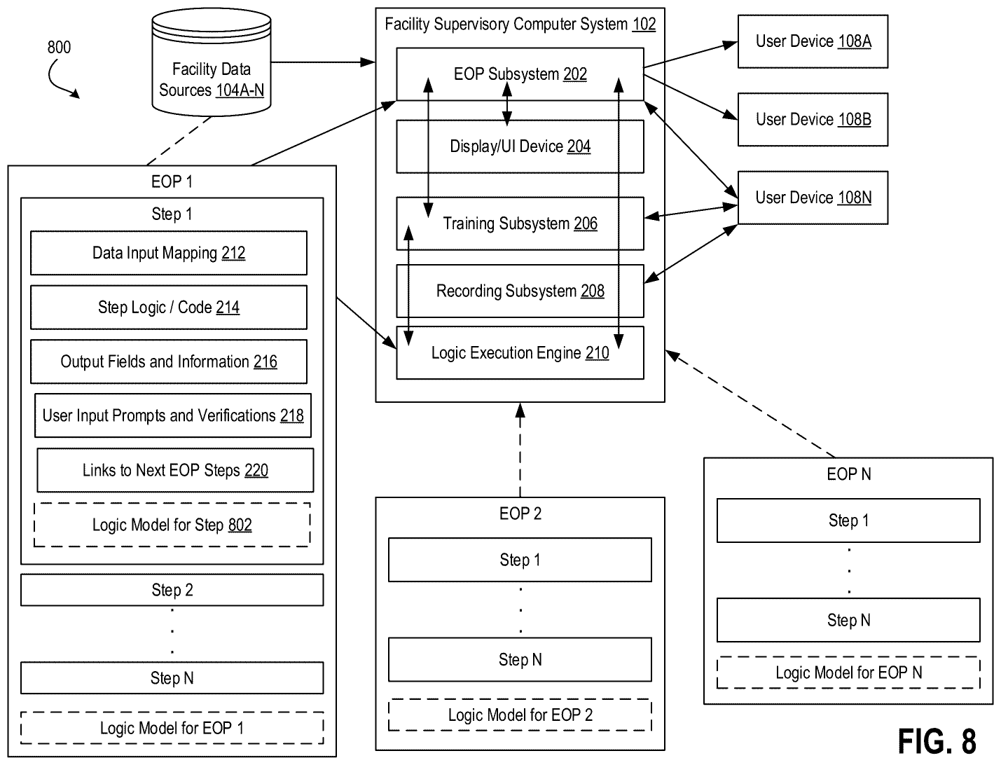

FIG. 8 is another system diagram of components and data objects using the disclosed techniques for making computer-based determinations about conditions in a facility and performance of EOP steps in response to a detected event in the facility. A system 800 can be similar to the system 200 described in FIG. 2. For example, the system 800 can include the facility supervisory computer system 102, the facility data sources 104A-N, the user devices 108A-N, and the EOP 1-N data objects. These components of the system 800 are described further in reference to FIG. 2.

More particularly, the facility supervisory computer system 102 can include the logic execution engine 210. The logic execution engine 210 can be configured to make determinations. The determinations can include determining whether one or more required manual actions have been successfully completed. Sometimes, the determinations can include determining whether one or more manual actions are required to be completed. In some implementations, the determinations can include determining and/or tracking progress through EOP steps by one or more relevant users (and/or the EOP subsystem 202 of the facility supervisory computer system 102).

The logic execution engine 210 can improve operation of facilities, such as nuclear power plants. The addition of the logic execution engine 210 can help provide efficient and safe operation of the facility. The logic execution engine 210 can also provide for directing actions to relevant users while allowing other users to maintain certain roles, such as an oversight role, to ensure that a human-machine interface remains in-sync during mitigation of a detected event in the facility.

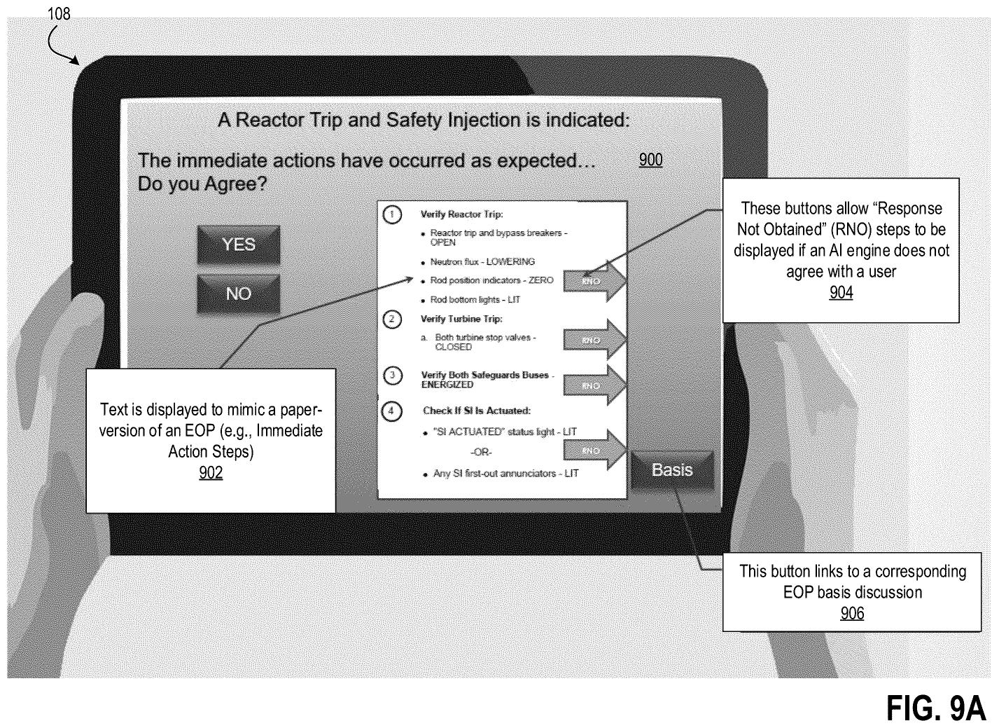

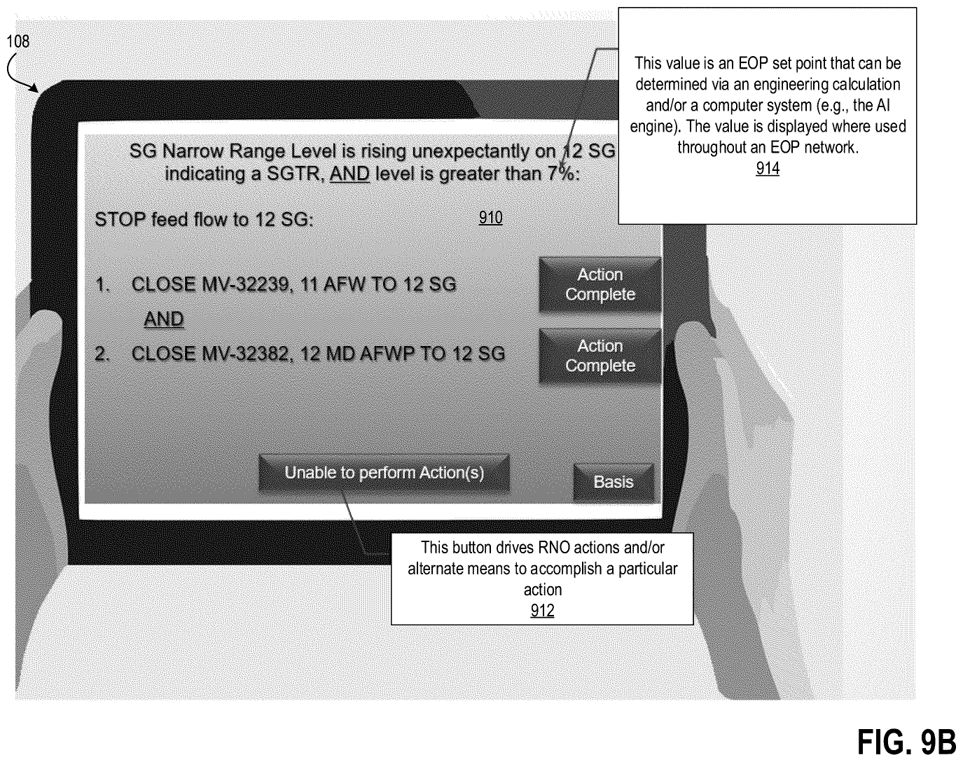

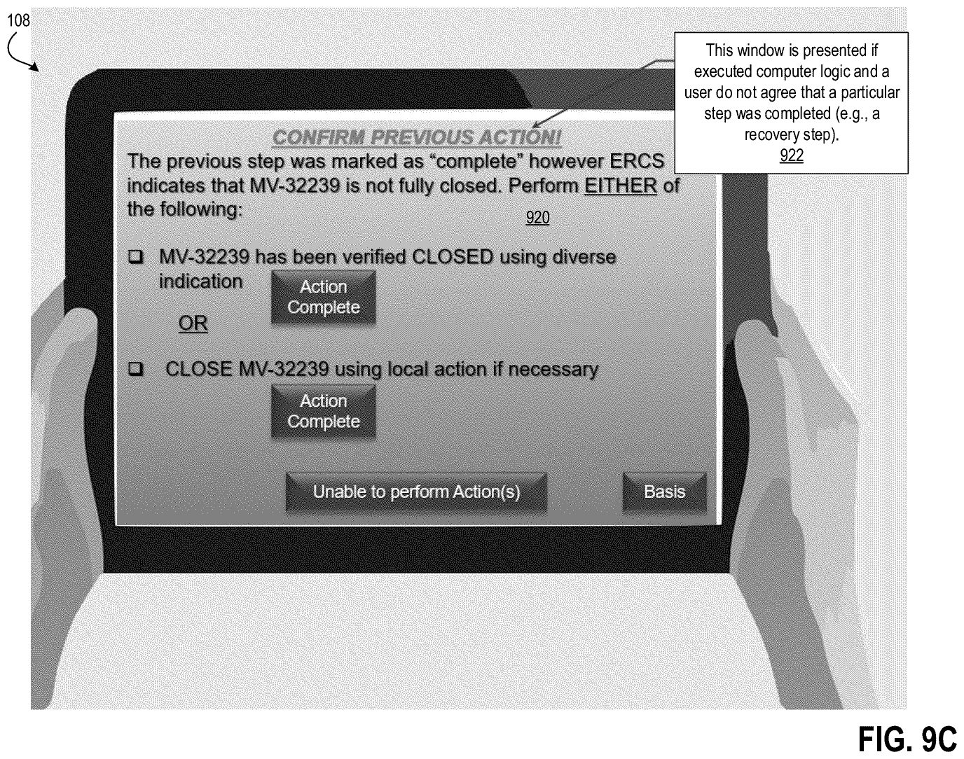

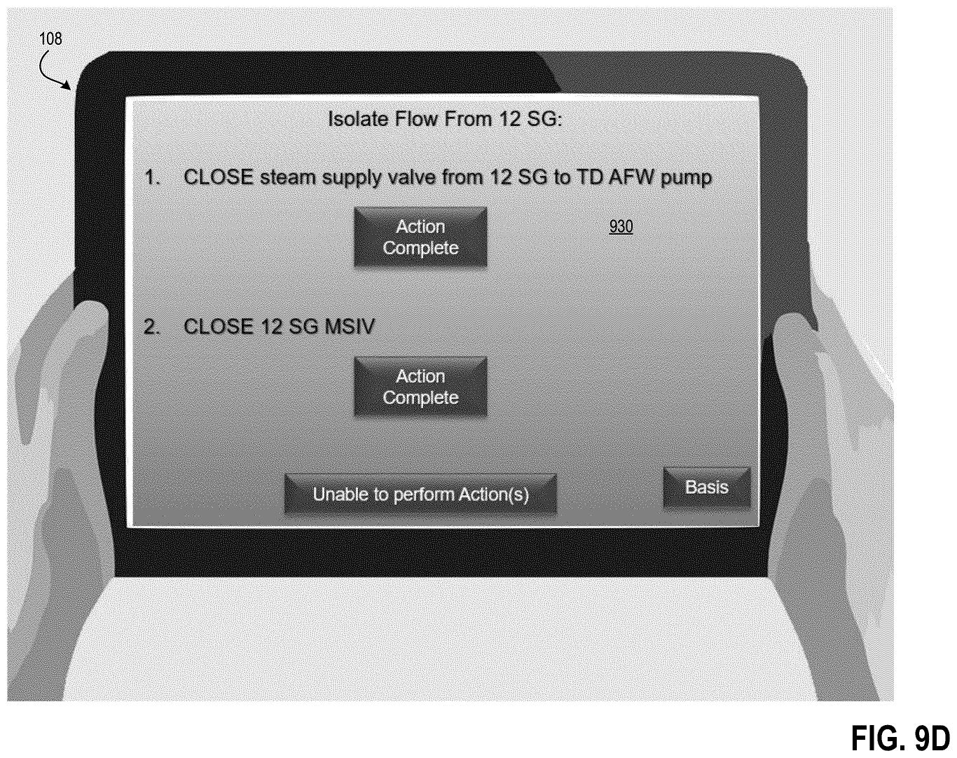

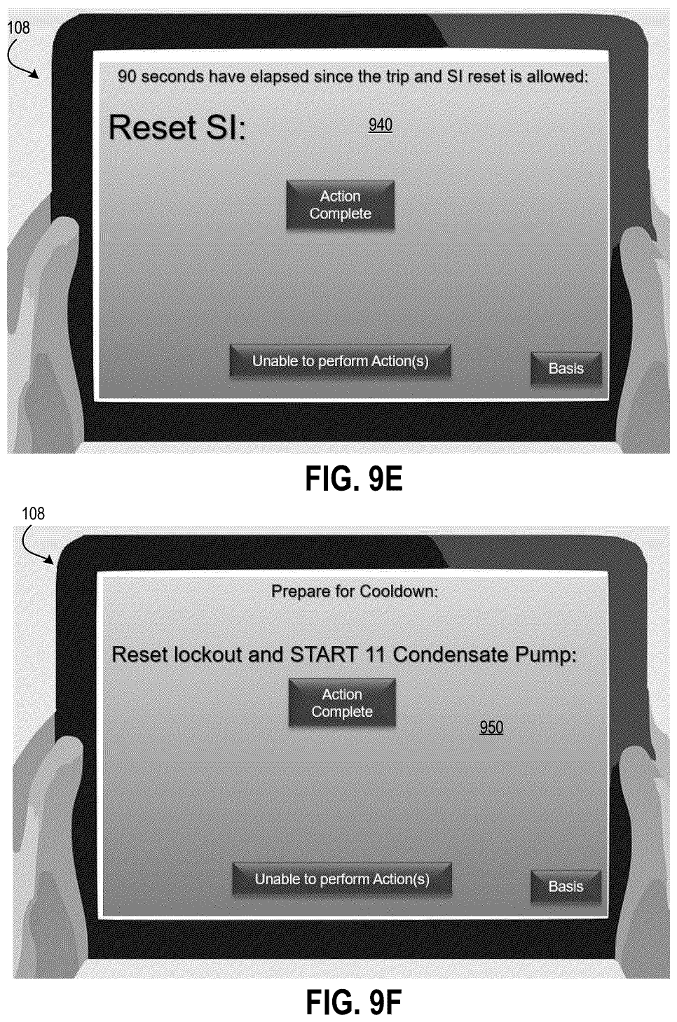

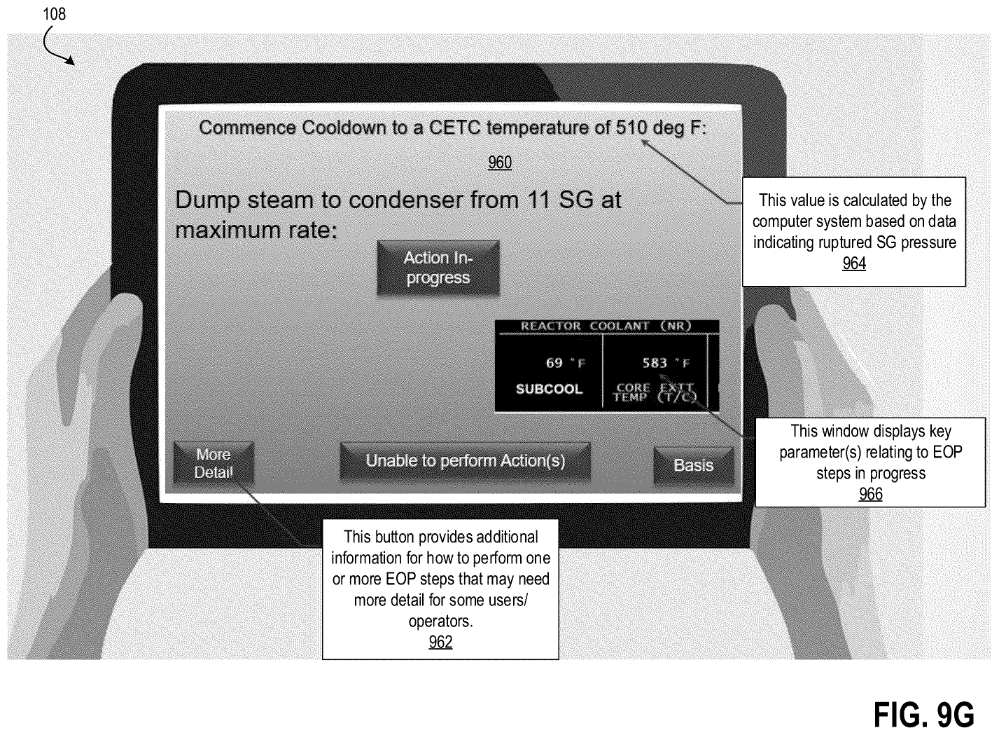

Each of the EOP 1-N data objects can include a respective logic model (e.g., Logic Model for EOP 1-N). The model can be trained using machine learning techniques to make determinations that are specific to the particular EOP. In some implementations, each of the steps 1-N of an EOP can include a respective logic model 802. The step-based model can be trained using machine learning techniques to make determinations that are specific to the particular step in the EOP. The logic model 802 and/or the model for the respective EOP 1-N can be loaded up into the logic execution engine 210. Data and other inputs received at the EOP subsystem 202 can be transmitted to the logic execution engine 210. Using the data as inputs to the logic execution model, the logic execution engine 210 can make one or more determinations described herein. Refer to FIGS. 9A-G for further discussion about example determinations that the logic execution engine 210 can make. In some implementations, the respective logic model 802 and/or the Logic Model for EOP 1-N can be computer logic and/or algorithms that are supported by trained or otherwise programmed models.

Determinations made by the logic execution Engine 210 can also be fed to the training subsystem 206. The training subsystem 206 can use these determinations as inputs to determine one or more recommendations about improving training and/or performance of relevant users when responding to events using the EOPs. In some implementations, the logic execution engine 210 can generate the recommendations based on data that the training subsystem 206 receives for training/improvement purposes.

Determinations made by the logic execution engine 210 can be transmitted to the EOP subsystem 202. Using the output fields and information 216 and/or the user input prompts and verifications 218, the EOP subsystem 202 can determine how to present the logic execution engine 210 determinations in a GUI at one or more of the user devices 108A-N. The EOP subsystem 202 can also apply one or more rules to identify which of the computer-based determinations should be checked/verified by a user at one or more of the user devices 108A-N. The EOP subsystem 202 can then transmit instructions to the display/UI device 204 and/or one or more of the user devices 108A-N to present the determinations made by the logic execution engine 210. Refer to FIGS. 9A-G described below for further discussion about displaying the computer-based determinations.

FIGS. 9A, 9B, 9C, 9D, 9E, 9F, and 9G illustrate example graphical user interface (GUI) displays presenting real-time progress through steps of an electronic version of an EOP with computer-based determinations and human checkpoints. The GUI displays can be presented at a user device 108 of one or more relevant users in a facility.

GUI 900 in FIG. 9A shows that a reactor trip and safety injection has been indicated. The GUI 900 can include a prompt asking the user to verify that immediate actions have occurred as expected. Text can be displayed to mimic a traditional paper version of an EOP that would be performed in response to the reactor trip and safety injection indication (902). The text can include any of the electronic versions of the EOP described herein. Each step of the EOP can also include a respective button for “Response Not Obtained” (RNO), which can be displayed if an logic execution engine 210 described herein (refer to FIG. 8) does not agree with input from the user (904). The GUI 900 may also present a “Basis” button, which can be selected to link the GUI 900 to a corresponding EOP basis discussion (906). The EOP basis discussion can provide additional information about why a particular EOP step is designed as such and how to implement the step.

GUI 910 in FIG. 9B shows that an SG narrow range level is rising unexpectedly on a particular SG, which indicates a SGTR and that such level is greater than a predetermined EOP setpoint (e.g., 7%). The EOP setpoint can be determined via an engineering calculation and/or a computer system (e.g., the engine 20 described in reference to FIG. 8) (914). The predetermined EOP setpoint can be displayed where used throughout an EOP network. The GUI 910 can also include instructions for a manual action to be performed to stop a feed flow to 12 SG. One or more steps can be presented in the GUI 910 in order to guide the user to perform the manual action. The GUI 910 can also present one or more selectable options/buttons for the user to confirm that the action was completed. The GUI 910 can include a selectable option for “Unable to perform Action(s),” which can drive RNO actions and/or alternative means to accomplish a particular action (912).

GUI 920 in FIG. 9C can be presented if the logic execution engine 210 (or other executed computer logic described herein) and the user do not agree that a particular step was completed (e.g., a recovery step) (922). The GUI 920 can prompt the user to confirm one or more previous actions as actually being completed.

GUI 930 in FIG. 9D can present a manual action to be performed to isolate flow from the particular SG. In the example of the GUI 930, one or more actions can be presented that instruct the user what to do to complete the respective actions. The GUI 930 can also include one or more selectable options/buttons to mark the actions as being completed.

GUI 940 in FIG. 9E can indicate that a certain amount of time elapsed since the Rx trip and SI reset was allowed. Therefore, the GUI 940 can include instructions or a prompt instructing the user to reset the SI. The GUI 940 can also include a selectable option/button to mark the action as complete.

GUI 950 in FIG. 9F can present another manual action to prepare for cool down. The GUI 950 can provide instructions for performing such action and a selectable option/button to mark the action as complete.

GUI 960 in FIG. 9G can present instructions for beginning the cool down process to a predetermined temperature value. The predetermined temperature value can be calculated by a computer system using computer logic or other algorithms described herein or the logic execution engine 210 (964). The predetermined temperature value can be determined based on data received from facility data sources (e.g., sensors) indicating ruptured SG pressure. Sometimes, the GUI 960 can include one or more graphical elements, selectable options/buttons, and/or visual displays indicating key parameters relating to EOP steps in progress (966). The GUI 960 can also include a “More Detail” selectable option/button to provide additional information about how to perform one or more EOP steps (962).

The GUIs shown in FIGS. 9A-G can be presented in the order shown and described herein. The GUIs can be presented as part of the electronic version of the EOP that is selected and performed in response to the reactor trip and safety injection event in the facility. Similar GUIs can also be generated and presented at relevant users devices in response to detection of different types of events in the facility, which may require performance of different EOPs.

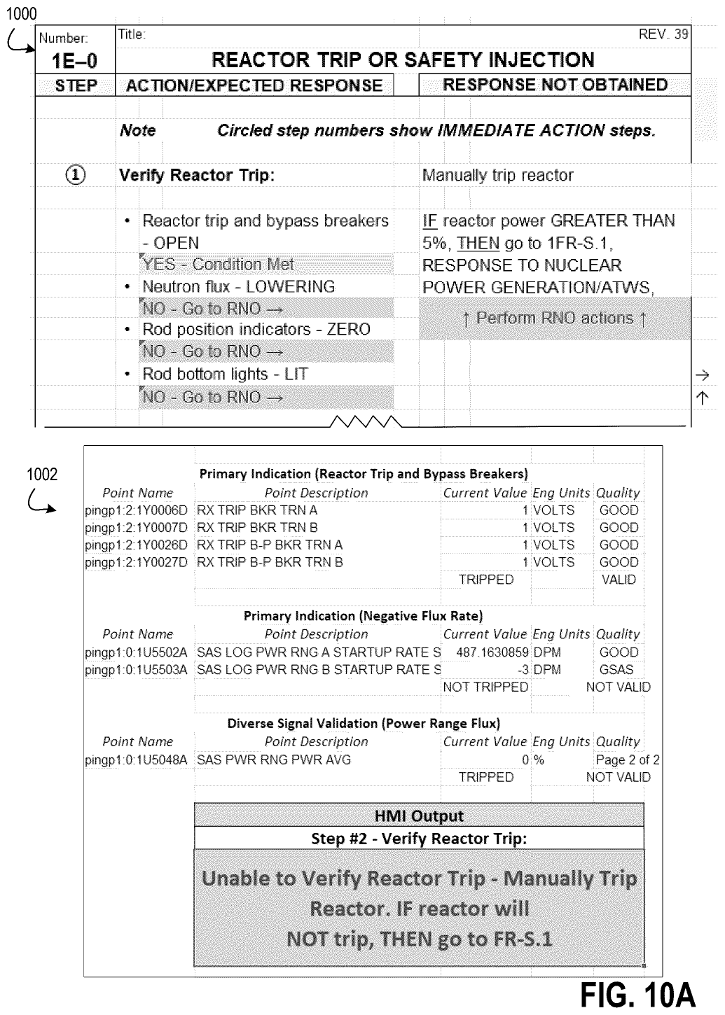

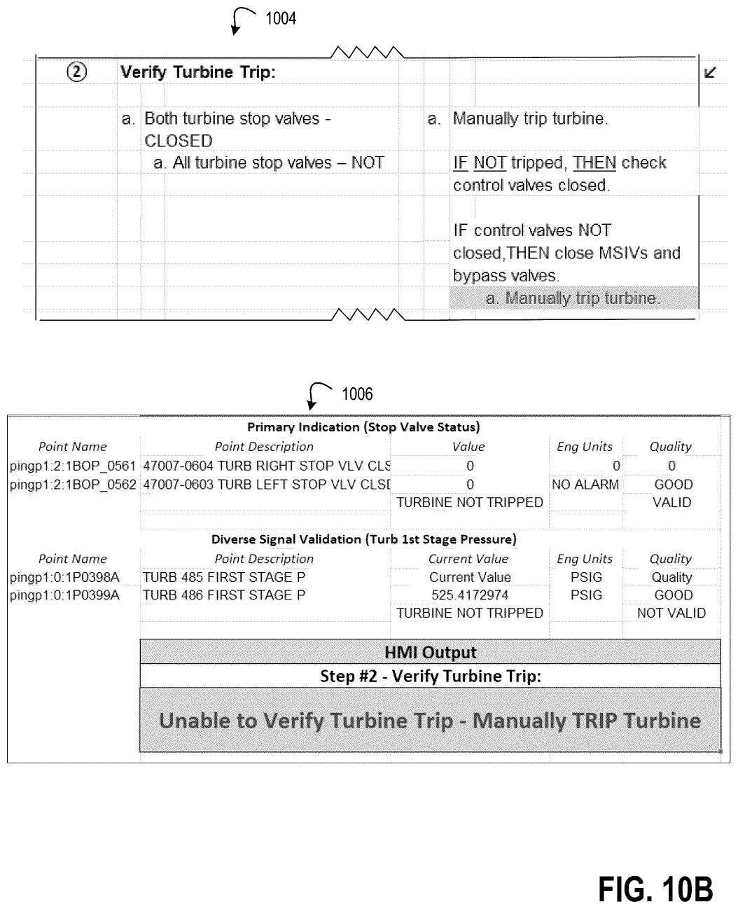

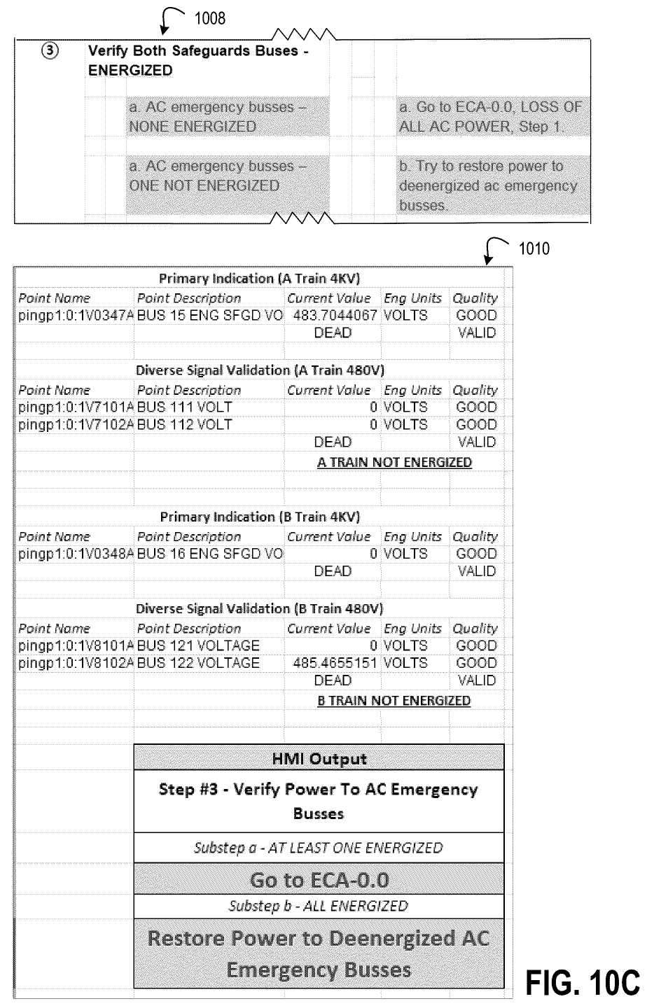

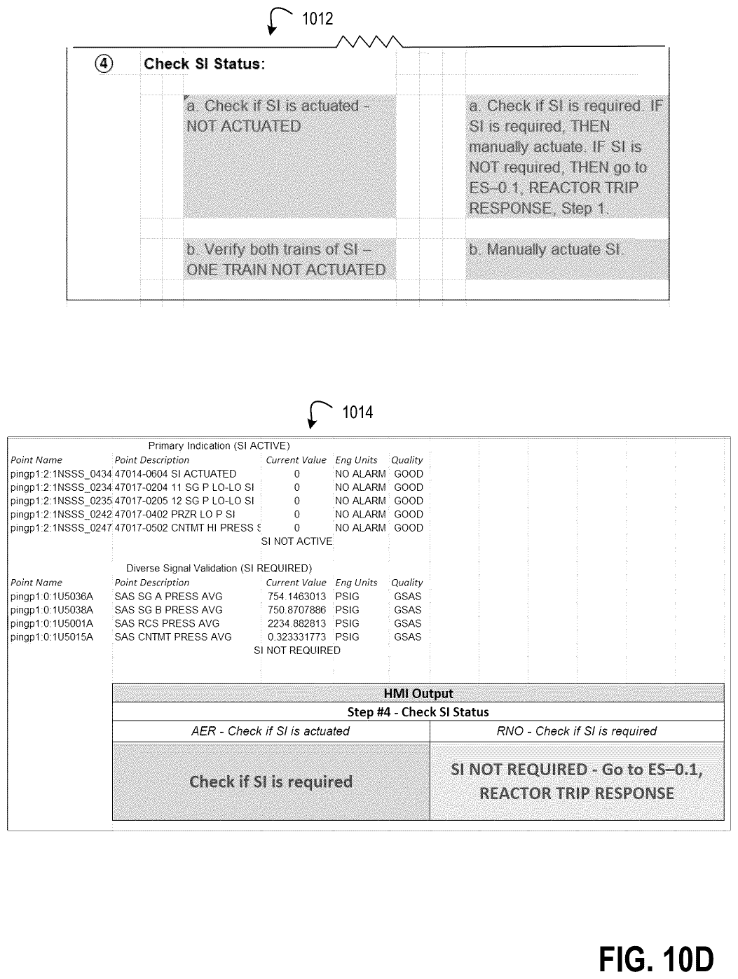

FIGS. 10A, 10B, 10C, and 10D illustrate example electronic versions of an EOP set of steps and corresponding computer logic that is executed to make determinations corresponding to each step. The logic can include a set of steps and/or determinations to be made, which a computing system can iterate through. The logic can be executed by the EOP subsystem 202 of the facility supervisory computer system 102, as described further in reference to at least FIG. 2. In some implementations, the logic can be executed by one or more other computing systems, cloud-based systems, computing devices, and/or networks of computing devices. Refer to FIGS. 4-6 for further discussion about the electronic version of the EOP set of steps.

FIG. 10A illustrates an example electronic version of step 1 1000 in an EOP entitled 1E-0. FIG. 10A shows corresponding computer logic 1002 that can be performed as described herein so that the step 1 1000 can be completed efficiently and accurately (e.g., completed automatically by the computing system and/or completed by one or more user manual actions). As shown in FIG. 10A, for each sub step of the step 1000, the logic 1002 can be executed to determine whether one or more respective conditions are met. As an illustrative example, for the first sub-step of checking a reactor trip and bypass breakers, the logic 1002 can be executed to check values of 4 points against one or more predetermined threshold values/ranges. For the second sub-step of checking a negative flux rate, the logic 1002 can be executed to check values of 2 points against one or more predetermined threshold values/ranges. The logic 1002 can also be executed to check various other values of a predetermined quantity of points against respective predetermined threshold values/ranges. The logic 1002 for the step 1 1000 can include checking values against predetermined points for parameters such as rods at bottom, reactor trip and bypass breakers, negative flux rate, and/or power range flux.

Based on the determinations made for each of the sub-steps by executing the logic 1002, the computing system can generate output for the step 1000. The example output shown in the logic 1002 indicates that the computing system was unable to verify the reactor trip and that an action must be taken by a user to manually trip the reactor. The output shown in the logic 1002 also indicates that if the reactor will not trip, then the computing system must proceed to performing steps in another EOP, FR-S.1. The output can be presented for the step 1000, such as in the column entitled “Response Not Obtained,” which is described further above in reference to FIGS. 4-6. The output can be determined using the following illustrative formula: if the rods at bottom current value is tripped and the quality is valid, the reactor trip and bypass breakers current value is tripped and the quality is valid, the negative flux rate's current value is tripped and the quality is valid, and the power range flux current value is tripped and the quality is valid, then the output indicates that the reactor trip is verified—otherwise, the output indicates that the computing system is unable to verify the reactor trip.

FIG. 10B illustrates an example electronic version of step 2 1004 in the EOP entitled 1E-0 (also shown in FIGS. 10A, 10C, and 10D). FIG. 10B shows corresponding computer logic 1006 that can be performed as described herein so that the step 2 1004 can be completed efficiently and accurately (e.g., completed automatically by the computing system and/or completed by one or more user manual actions). In the illustrative example of the computer logic 1006, the computing system can check multiple values against predetermined threshold values/ranges to generate output corresponding to the step 2 1004. The logic 1006 can be executed to check one or more values/points for stop valve status and one or more values/points for diverse signal validation (e.g., turbine 1^{st} stage pressure).

Based on checking such values/points against respective threshold values/ranges, the computing system generates output for the step 2 1004. Here, the generated output indicates that the computing system was unable to verify the turbine trip and that a user must manually trip the turbine. The output can be generated using a formula such as the following: if the stop valve status value is turbine tripped and the quality is valid and the turbine 1^{st} stage pressure current value is turbine tripped and the quality is valid, then the computing system can generate output indicating that the turbine trip is verified—otherwise, the computing system generates output indicating that it was unable to verify the turbine trip and to manually trip the turbine.

FIG. 10C illustrates an example electronic version of step 3 1008 in the EOP entitled 1E-0 (also shown in FIGS. 10A, 10B, and 10D). FIG. 10C shows corresponding computer logic 1010 that can be performed as described herein so that the step 3 1008 can be completed efficiently and accurately (e.g., completed automatically by the computing system and/or completed by one or more user manual actions). In the illustrative example of the computer logic 1010, the computing system can check multiple values against predetermined threshold values/ranges to generate output corresponding to the step 3 1008. The logic 1010 can be executed to check one or more values/points for A train 4 KV, A train 480V, B train 4 KV, and B train 480V. Based on checking such values/points against respective threshold values/ranges, the computing system generates output for the step 3 1008. Here, the generated output indicates that the computing system determined that none of the AC emergency busses have been energized. As a result, the computing system generates output instructing a user to proceed to a next EOP set of steps, entitled ECA-0.0. The computing system can also generate output instructing the user to restore power to the de-energized AC emergency busses, as shown with the step 3 1008.

The output can be generated using multiple formulas. For example, the logic 1010 can include generating output for checking whether at least one AC emergency bus is energized using the following formula: if the A train is energized and the B train is energized, then the computing system can generate output indicating that power to the at least one AC emergency bus is verified—otherwise, the computing system generates output indicating that the user must proceed with completing steps in the EOP ECA-0.0. Similarly, if the A train is energized and the B train is energized, the computing system can generate output indicating that all the AC emergency busses are energized and thus the power is verified—otherwise, the computing system can generate output instructing the user to restore power to the one or more de-energized AC emergency busses.

FIG. 10D illustrates an example electronic version of step 4 1012 in the EOP entitled 1E-0 (also shown in FIGS. 10A, 10B, and 10C). FIG. 10D shows corresponding computer logic 1014 that can be performed as described herein so that the step 4 1012 can be completed efficiently and accurately (e.g., completed automatically by the computing system and/or completed by one or more user manual actions). In the illustrative example of the computer logic 1014, the computing system can check multiple values against predetermined threshold values/ranges to generate output corresponding to the step 4 1012. The logic 1014 can be executed to check one or more values/points for SI active and SI required. Based on checking such values/points against respective threshold values/ranges, the computing system generates output for the step 4 1012. Here, the generated output indicates, for checking if the SI is actuated, that a user must manually check if the SI is required. The generated output also indicates, for checking if the SI is required, that the SI is not required, and that the user can proceed to EOP ES-0.1, which corresponds to a reactor trip response. The output can be generated using one or more formulas. For example, for checking if the SI is actuated, the formula can include the following: if the SI active current value is SI active, then verify both trains of SI as actuated—otherwise, the computing system generates output instructing the user to check if the SI is required. For checking if the SI is required, the formula can include the following: if the SI required current value is SI not required, then generate output indicating that the SI is not required and go to ES-0.1, reactor trip response—otherwise, the computing system can generate output indicating that the SI is required and that the user must manually actuate the SI.

Although FIGS. 10A-D show 4 example EOP steps and corresponding logic, an EOP can have fewer or additional steps and corresponding logic.

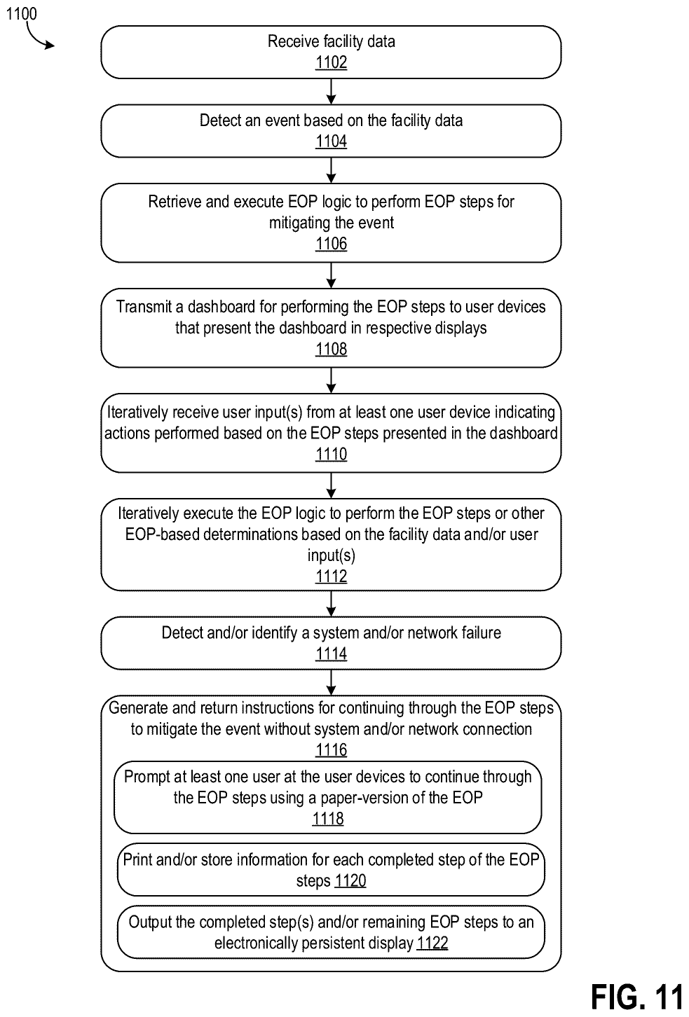

FIG. 11 is a flowchart of a process 1100 for maintaining continuous progress through and completion of an EOP set of steps when an electronic version of the EOP is unavailable or inaccessible. Sometimes, a computer and/or network connection may fail or become temporarily unavailable during an event, accident, emergency, etc. The EOP steps still must be performed to ensure the event is appropriately, safely, and efficiently handled. Thus, the process 1100 can be performed to ensure that relevant users continue through the EOP steps where they left off before the electronic version of the EOP became unavailable or inaccessible.

Sometimes, a bitflip may occur as part of or as a result of the event, accident, or emergency in the facility. Bitflips can cause individual bits stored in an electronic device, computing system, data store, etc. to flip, turning a 0 to a 1 or vice versa. Cosmic radiation and fluctuations in power or temperature can cause the bitflips. In order to address scenarios where bitflips may occur, additional and/or redundant secure memory locations can be used to store EOP progress, completion of EOP steps, and/or data/results collected/generated during completion of the EOP steps before the bitflip occurred. Data related to the EOP can be stored in bits across different memory so that if one of such storage locations is corrupted or otherwise compromised by a bitflip, the data related to the EOP can still be recovered from the other storage locations. Therefore, data related to the EOP can be recovered and provided to relevant users to continue through the EOP steps and mitigate the event.

The process 1100 can be performed by the facility supervisory computer system 102 or any other computing system described herein. The process 1100 can also be performed by any other computing system, computing device, cloud-based system, and/or network of computing systems/devices. For illustrative purposes, the process 1100 is described from the perspective of a computing system.

Referring to the process 1100, the computing system can receive facility data in block 1102. Refer to at least block A (120) in FIG. 1 and block 702 in the process 700 for further discussion.

The computing system can detect an event based on the facility data in block 1104. For example, the computing system may detect a reactor trip and safety injection, as described in reference to at least FIGS. 7A-C and 9A-G. The computing system may detect/identify any other types of events, emergencies, and/or accidents in the facility that may cause performance or triggering of a set of EOP steps.

The computing system can retrieve and execute EOP logic to perform EOP steps for mitigating the event (block 1106). Refer to at least FIG. 2 and the process 300 in FIG. 3 for further discussion.

In block 1108, the computing system can transmit a dashboard for performing the EOP steps to user devices that present the dashboard in respective displays. Refer to FIGS. 4-6 for illustrative examples of an electronic version of the EOP steps that can be performed at the user devices. Refer to FIGS. 9A-G for further discussion about illustrative examples of the dashboard that can be presented at the user devices.

The computing system can iteratively receive user input(s) from at least one user device indicating actions performed based on the EOP steps presented in the dashboard (block 1110). Instead of iteratively receiving the user input(s), the computing system can receive the user input whenever it is provided by a user at the at least one user device. Refer to at least the process 700 in FIGS. 7A-C and FIGS. 9A-G for further discussion.

The computing system can iteratively execute the EOP logic to perform the EOP steps or other EOP-based determinations based on the facility data and/or user input(s) (block 1112). Refer to at least FIG. 2, the process 300 in FIG. 3, the process 700 in FIGS. 7A-C, and the FIGS. 9A-G for further discussion. Sometimes, the block 1112 can be performed continuously, such as in the background, during any of the processes described herein. In other words, the computing system can continuously work through the EOP logic to ensure that the event is appropriately handled and that the EOP steps are in fact completed. In some implementations, block 1110 can occur after or during block 1112.

In block 1114, the computing system can detect and/or identify a system and/or network failure. A communication error can arise, such as a shortage or cut to power or other temporary break in network communication/connection. Sometimes, the failure can occur as a result of the detected event in the facility. One or more other types of computer/network failures may arise as a result and cause temporary inability to communicate information between computing systems and components described throughout this disclosure.

The block 1114 can be performed at any point before, during, or after any of the blocks in the process 1100. For example, shortly after the event is detected, a network failure can occur, which may prevent real-time facility data from being transmitted between facility components and used by the computing system to perform the other blocks in the process 1100. As another example, the system and/or network failure may be detected while one or more of the blocks are being performed, such as when the computing system is receiving user input, waiting for user input, executing the EOP logic, performing one or more of the EOP steps, making other EOP-based determinations, etc.

In response to determining or identifying the failure, the computing system can generate and/or return instructions for continuing through the EOP steps to mitigate the event without system and/or network connection (block 1116).

For example, the computing system can prompt at least one user at the user devices to continue through the EOP steps using a paper version of the EOP (block 1118). The computing system may present, at the user's device, information indicating the last action/verification performed by the computing system and/or the user in the electronic version of the EOP. Information that was determined by the computing system as part of executing the EOP logic can also be presented to help guide the user to quickly, efficiently, and accurately pick up where they left off. The user can then retrieve the paper version of the EOP and pick up at a next step (or current step) based on the information provided in block 1118.

As another example, the computing system can print and/or store information for each completed step of the EOP steps (block 1120). The computing system can send information for each step once completed to a printer or storage device (e.g., memory, RAM, ROM). That way, any relevant user can access the stored/printed EOP steps to review progress through the EOP steps and/or determine how to proceed once the system and/or network failure occurs. The computing system can also send information about the completed EOP steps to the printer once the failure occurs (or after a predetermined quantity of actions or steps for the EOP has been performed).

As yet another example, the computing system may output the completed step(s) and/or remaining EOP steps to an electronically persistent display (block 1122). As a result, the relevant users can continue through the EOP steps, uninterrupted despite the system and/or network failure. Once the system and/or network failure is resolved, any changes/inputs made by the relevant users at the electronically persistent display can be automatically uploaded to the computing system. The computing system can then update the electronic version of the EOP steps accordingly so that the user can continue through the EOP steps without interruption, and as described herein.

Sometimes, a backup battery or temporary power source can be used to allow information shown at displays of the user devices to continue to be displayed after a power failure occurs. The backup battery or temporary power source can, for example, cause the user device display to be locked in, meaning the respective user can continue to see the information that was presented at the display (e.g., a static version of completion of the EOP set of steps) before the power failure (e.g., just before the power failure, shortly before the power failure, a predetermined amount of time before the power failure). One or more other hardware components and/or software processes can be used in combination with the computing system and user devices described herein to allow for the information to continue to persist on the displays of the user devices.

In some implementations, once the computer or network failure is resolved, the computing system can receive scans of the completed paper-based version of the EOP, process the scans, and populate the electronic version of the EOP with user input/completion of the EOP steps as indicated in the processed paper version of the EOP. A user can take an image/picture of the paper-based version of the EOP with their user device, which can then be processed by the user device or the computing system. In some implementations, the scan can be captured by a scanning device and then transmitted to the user device and/or the computing system for further processing. Image processing techniques or other types of techniques can be used to extract relevant data, inputs, and other information provided by users on the paper version of the EOP. The extracted information can then be applied, by the computing system, to relevant fields, text fields, and/or inputs in the electronic version of the EOP. Therefore, the computing system can quickly, efficiently, and automatically populate the electronic version of the EOP with the information corresponding to EOP progress made using the paper-based version of the EOP when the computer or network failure occurred. The computing system can perform one or more of the disclosed techniques to continue progress through the EOP using the electronic version of the EOP. Sometimes, the computing system can generate and provide multiple human checkpoints and/or verifications to confirm the information that was automatically added to the electronic version of the EOP. The user can seamlessly continue through the EOP steps using the electronic version. In some implementations, even if the computer or network failure is resolved, the user may continue using the paper-based version of the EOP. Once the user completes the EOP steps in the paper-based version of the EOP, the paper-based version can be scanned and processed by the computing system as described above. As a result, a single centralized record can be made of the progress through the EOP for the particular event in the facility.

FIG. 12 is a conceptual diagram of a system 1200 for replicating user interactions with an electronic version of an EOP set of steps across multiple different user devices associated with a facility having a detected event. As a result, various users in the facility can use their respective devices to monitor status of the EOPs, regardless of their location in the facility (and/or their role/responsibility in the facility). As an illustrative example, a supervisor can make determinations from a control room in the facility and can oversee/review an entire process of completing the EOP steps in the facility. Sometimes, the supervisor may also be in charge of triggering human checkpoints/verifications as being successfully completed or not. Other users in the facility can also review the EOP status/progress and/or provide input such as completing manual actions assigned to one or more EOP steps from their respective user devices. The system 1200 can beneficially provide for users outside of the control room to be engaged in the process of completing EOPs and successfully and safely mitigating events, accidents, or emergencies in the facility. Such broadcasting and teamwork completion of the EOPs can beneficially provide for improved response time and response effectiveness. The system 1200 can also be used to improve EOPs over time, track current EOP status, train relevant users to better respond to the detected event and/or complete EOPs, and/or make real-time adjustments to the facility to improve mitigation of the detected event.

The system 1200 can include the facility supervisory computer system 102 and one or more user devices 108A-N that communicate (e.g., wired, wirelessly) via networks described herein.

Referring to FIG. 12, the user device 108A can receive user input indicating completion of an action in an EOP set of steps presented at the user device 108A (block A, 1202). The user device 108A can present an electronic version of an EOP 1220. The electronic version of the EOP 1220 can be similar to any of the electronic versions of the EOP described herein. The user input received in block A (1202) can include verifications made by the user indicating that particular actions in the EOP steps have been successfully completed.

The user input can be transmitted to the facility supervisory computer system 102 in block B (1204).

In block C (1206), the facility supervisory computer system 102 can execute EOP and/or EOP step logic based on the user input to proceed through the EOP set of steps.

The facility supervisory computer system 102 can also transmit instructions to present real-time progress through the EOP set of steps based on executing the logic to the user device 108A (block D, 1208). The real-time progress can be presented in the electronic version of the EOP 1220, as describe herein.

The facility supervisory computer system 102 can also transmit instructions for presenting real-time indicators of user progress at the user device 108N or other user devices or computing devices associated with the facility (block E, 1210). For example, the instructions can cause the user device 108N to present the electronic version of the EOP 1220 as a read-along/read-only version, in which the user at the user device 108N may not provide user input to complete required manual actions that are determined as part of the facility supervisory computer system 102 executing the EOP logic. Rather, the user at the user device 108N may simply follow along and watch the user at the user device 108A provide the user input in real-time or near real-time. A cursor or other visual indication 1224 can be presented as overlaying the electronic version of the EOP 1220 at the user device 108N to provide real-time following of what interactions the user is performing at the user device 108A.

In some implementations, the user at the user device 108N can also provide user input. For example, the user can be assigned one or more roles/responsibilities during the completion of the EOP set of steps. The user can be given the responsibility of verifying that one or more manual actions have been successfully completed because the user may be physically near/proximate facility equipment that involves the manual actions.

Sometimes, various responsibilities can be doled out to users at different user devices 108A-N, and instructions/notifications can be presented at those user devices 108A-N when action/user input is required. The other user devices 108A-N can also receive instructions from the facility supervisory computer system 102 to present the real-time progress of the user device(s) 108A-N where the user is performing/verifying the action(s). The users at the user devices 108A-N can view real-time progress through the EOP steps while the EOP steps can also be handled by multiple users to more efficiently complete the EOP steps and safely mitigate the event.

Blocks D (1208) and E (1210) can be performed simultaneously and/or before, during, or after any of the other blocks described in FIG. 12. Therefore, information concerning progress through the EOP steps can be presented in real-time at various different user devices 108A-N so that relevant users throughout the facility and external to the facility can monitor the progress.

Before, during, and/or after one or more of the blocks A-E (1202-1210), the facility supervisory computer system 102 can iteratively record facility data, user inputs, and/or time sequence of progress through each step of the EOP set of steps (block Z, 1212). The facility supervisory computer system 102 can record such information, as described at least in reference to the recording subsystem 208 in FIG. 2. In some implementations, the facility supervisory computer system 102 can have a tracker and/or timer mechanism that keeps track of where users are in completion/review of the EOP steps, how long it takes each user to complete/review each of the EOP steps, etc. This information can provide insight about who and how many users may make mistakes during completion of the EOP steps and/or whether they are implementing correct actions in a timely manner to safely mitigate the detected event. Any of the information recorded by the facility supervisory computer system 102 can also be paired with audio, video, and/or screengrab to create more robust recordings. These recordings can then be used to improve training the users about responding to detected events and following the EOPs.

In some implementations, one or more licensed operators can implement the electronic version of the EOP 1220 at their respective user devices 108A-N, and only steps needing action can be read out loud to the relevant users for completion (instead of requiring all the steps to be read out loud as in the traditional paper-based approach of the EOP). Sometimes, one or more of the licensed operators can implement the electronic version of the EOP 1220 at their respective device, which can be used to verify expected facility alignment and indications (e.g., RG 1.97 instruments match computer indications used for the electronic version). Moreover, one or more of the licensed operators can independently monitor and advise on critical safety functions, EOP progression/transitions, and/or off-normal plant alignment and conditions using the electronic version of the EOP 1220 at their device. One or more of the licensed operators can also remain in a traditional ED and/or oversight role using the electronic version of the EOP 1220.

As described herein, the blocks A-E (1202-1210) can be performed to allow the one or more licensed operators to independently work through the EOP steps/actions on their own respective devices, without direction from one or more other licensed operators. Operators outside of the control room can also independently work through their applicable EOP step(s) without direction from the control room (e.g., unless local/manual action is needed). A particular licensed operator can continue to monitor successful completion of steps through their respective device. Another licensed operator can monitor a big picture of the detected event using the disclosed techniques to ensure the facility and crew response is as expected. Yet another licensed operator can also remain in the ED and oversight role(s). Checks and balances, such as indication validation, can be an independent responsibility given to one or more other users, such as a control room member. Accordingly, the facility supervisory computer system 102 can determine which actions are assigned to which users, and then transmit notifications with instructions for completing those actions to the devices of those users. The EOP steps can be completed efficiently while trying to safely mitigate the event.

FIG. 13 is a flowchart of a process 1300 for training users in a facility to improve performance of an EOP set of steps based on data that is collected and recorded during completion of an electronic version of the EOP set of steps. Sometimes, the process 1300 can be performed to determine whether and how to modify one or more EOP steps that are performed automatically by a computing system and/or manually by one or more relevant users.

The process 1300 can be performed to provide various training benefits. For example, using electronic versions of EOPs can make response to accident simple and efficient, which can equate to less training required for a same level of performance. This can also reduce costs to the facility. Initial training can be shorter since a simulator portion of the training can be trimmed down (e.g., trainees may not be required to train on reviewing and reading out loud each step in an EOP). Similarly, continuous training can also be shortened in length. Difficulty importance frequency (DIF) data may no longer be required. Instead, the DIF data can be replaced by human error data, which can be collected using the recording mechanisms described herein.

Human error data that is collected/recorded using the disclosed technology can be used to improve training of the relevant users, as described further below. The human error data and other collected data can also be integrated with reports and other records for maintenance of EOP response programs in the facility. Data collected while the electronic version of the EOP can further be used to help predict and identify likely error points and timing of step or strategy completion. This data can be fed back into the computing system described herein to determine how to optimize the EOP and other strategies.

Traditionally, a paper version of an EOP can be laminate, which means once the paper version of the EOP is used and a corresponding event in the facility is mitigated/dealt with according to the EOP steps, the paper version of the EOP is cleaned. Cleaning the paper version of the EOP can include erasing all markings, notes, and/or determinations that were made by relevant users working through the EOP steps. As a result, the facility may not maintain permanent, systematic, and/or objective mechanisms for checking a process of completing EOP steps, progress through the EOP steps, etc. The disclosed technology, on the other hand, provides data-based mechanisms to record progress through completing the electronic version of the EOP steps. These data-based mechanisms can be used to generate insights about the progress (such as how long it takes a particular user, group of users, or average user) to work through one or more particular actions and/or steps in the EOP. Insights can be learned from such recordings to determine how to improve training of the user(s) and overall performance of the EOP steps.

The process 1300 can be performed by the facility supervisory computer system 102, and more particularly the training subsystem 206 described in reference to FIG. 2. The process 1300 can also be performed by any other computing system, computing device, cloud-based system, and/or network of computing devices. For illustrative purposes, the process 1300 is described from the perspective of a computing system.

Referring to the process 1300 in FIG. 13, the computing system can retrieve recorded facility data, user inputs, and/or time sequence of progress through an EOP set of steps during an event in a facility (block 1302). Any of the data retrieved in block 1302 can be recorded/generated by the recording subsystem 208 described in reference to FIG. 2. The retrieved data can include user inputs that are provided while respective users are checking, verifying, or otherwise performing one or more actions and/or steps in an EOP that is displayed at their respective devices. The retrieved data can include sensor values or other parameters that are measured by one or more data sources in the facility during the event in the facility and/or while the relevant users are completing the EOP steps to mitigate the event. The retrieved data can include timing data that is measured by the computing system indicating how long a user remains on/reviews one or more actions and/or steps in the EOP set of steps, how long it takes a user to complete one or more actions and/or steps in the EOP set of steps, how long it takes users in the facility to complete the EOP set of steps or otherwise mitigate the event, etc.

The retrieved data can also include audio recording, video recordings, and/or screengrabs that are generated by the recording subsystem 208 when the user(s) work through the electronic version of the EOP set of steps at their respective device(s). For example, the screengrabs can show user interaction with the electronic version of the EOP set of steps, such as the user's cursor tracking through different actions, reviews, checks, button presses, etc. As another example, the screengrabs can illustrate what information was presented at the respective user device(s) at one or more timestamps during completion of the electronic version of the EOP. As another example, the audio recordings can indicate audio communications made between one or more users in the facility while completing the electronic version of the EOP or otherwise mitigating the event (e.g., a user in a control room instructing a user out in the field to manually check one or more components, a user in the field contacting the user in the control room with an update on actions that are manually performed in the field, etc.). As yet another example, the video recordings can include videos that are captured by imaging devices in the facility indicating the actions performed by the users in the facility according to the EOP steps and determinations made by the computing system. The video recordings can also include recordings of the actions performed at each user's device, similar to the screengrabs described herein.

In block 1304, the computing system can select a step from the EOP set of steps. The computing system can work through each of the EOP steps, in an order in which the steps are performed during the event in the facility. Sometimes, the computing system can select the step having the most related retrieved data. Sometimes, the computing system can receive an indication from a user device indicating which of the EOP steps to assess.

The computing system can determine whether the retrieved data indicates that the selected step was performed according to one or more step-completion criteria (block 1306). The one or more step-completion criteria can include one or more rules that are defined for the particular facility, for particular EOP steps, and/or for particular EOPs more generally. For example, the one or more criteria can indicate an expected response time for one or more users to address one or more particular actions and/or EOP steps. As another example, the one or more criteria can indicate one or more expected responses for the one or more users to address the particular action(s) and/or EOP steps. The one or more criteria can be defined based on a severity of the event in the facility. For example, the more severe/extreme the event, the greater urgency can exist to complete one or more of the particular action(s) and/or EOP steps and/or the less amount of time the one or more users may have to complete such actions and/or EOP steps. Various other criteria can be generated by relevant users in the facility and/or by the computing system described herein.

If the selected step was performed according to the one or more step-completion criteria, the computing system can generate information indicating proper completion of the selected step (block 1308). For example, if the computing system determines that an appropriate set of actions were performed by one or more users to perform a required manual action for the selected step, the computing system can determine that the step was appropriately completed by the user(s). If the computing system determines that the step was completed within or less than an expected period of time for completing that particular step, the computing system can determine that the step was appropriately completed.

The computing system can then determine whether there are more steps in the EOP set of steps to assess (block 1310). If there are more steps to assess, the computing system can return to block 1304 and proceed through the process 1300 until no more steps are available or ready to be assessed. If there are no more steps to assess, the process 1300 can stop. Sometimes, if there are no more steps to assess, the computing system can return information about one or more of the assessed steps. Returning the information can include storing the information in a data store. Returning the information can include transmitting instructions to one or more computing devices of relevant users in the facility.

Referring back to block 1306, if the computing system determines that the selected step was not performed according to the one or more step-completion criteria, the computing system can generate one or more recommendations to train relevant users to improve performance of the selected step based on the one or more step completion criteria (block 1312). The computing system can determine that the step was not performed according to the one or more step-completion criteria if, for example, the user(s) did not perform the appropriate actions to complete the step and/or perform a required manual action. As another example, the step may not be performed correctly if the computing system determines that the user(s) provided input/verification that was not an expected response and/or the user input/verification deviates from computer-based determinations (e.g., by more than a threshold or expected range). As yet another example, the step may not be performed correctly if the computing system determines that the user too longer than expected or preferred to complete one or more of the EOP steps.

The recommendations generated in block 1312 can include recommendations about how users should respond to particular actions and/or steps for the particular EOP. The recommendations can indicate how long it should take the user(s) to complete one or more particular actions and/or steps. The recommendations can indicate what training one or more of the users should participate in in order to remedy any mistakes and/or errors the user(s) made during real-time completion of the EOP steps. The recommendations can indicate what parameters, values, equipment, and/or facility components to check when completing the EOP steps during the event. One or more other recommendations can be generated to train the users and improve their overall performance of the EOP steps during future and/or similar events in the facility.

Sometimes, the logic execution engine 210 described in reference to FIG. 8 can be configured to generate the recommendations. The engine 210 can execute computer logic and/or algorithms that are supported by programmed/trained models. Such models can be trained to determine, based on the retrieved data, whether training may be needed to improve performance of the users in completing the EOP steps. The models can also be trained to determine, based on the retrieved data, how to train the users to improve their performance.

The computing system can then transmit the recommendation(s) to one or more user devices for training purposes (block 1314). In some implementations, the computing system can return the recommendations, such as storing the recommendations in a data store for later retrieval and/or use for training. The computing system can then proceed to block 1310, described above.

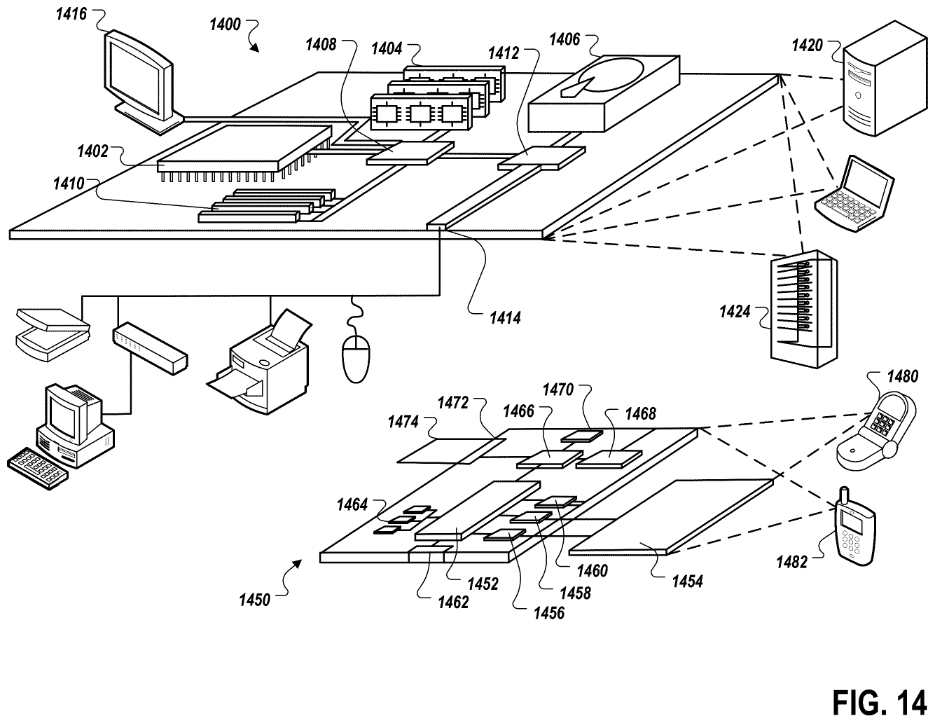

FIG. 14 shows an example of a computing device 1400 and an example of a mobile computing device that can be used to implement the techniques described here. The computing device 1400 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1400 includes a processor 1402, a memory 1404, a storage device 1406, a high-speed interface 1408 connecting to the memory 1404 and multiple high-speed expansion ports 1410, and a low-speed interface 1412 connecting to a low-speed expansion port 1414 and the storage device 1406. Each of the processor 1402, the memory 1404, the storage device 1406, the high-speed interface 1408, the high-speed expansion ports 1410, and the low-speed interface 1412, are interconnected using various busses, and can be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as a display 1416 coupled to the high-speed interface 1408. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 1404 stores information within the computing device 1400. In some implementations, the memory 1404 is a volatile memory unit or units. In some implementations, the memory 1404 is a non-volatile memory unit or units. The memory 1404 can also be another form of computer-readable medium, such as a magnetic or optical disk.

The storage device 1406 is capable of providing mass storage for the computing device 1400. In some implementations, the storage device 1406 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 1404, the storage device 1406, or memory on the processor 1402.

The high-speed interface 1408 manages bandwidth-intensive operations for the computing device 1400, while the low-speed interface 1412 manages lower bandwidth-intensive operations. Such allocation of functions is exemplary only. In some implementations, the high-speed interface 1408 is coupled to the memory 1404, the display 1416 (e.g., through a graphics processor or accelerator), and to the high-speed expansion ports 1410, which can accept various expansion cards (not shown). In the implementation, the low-speed interface 1412 is coupled to the storage device 1406 and the low-speed expansion port 1414. The low-speed expansion port 1414, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 1400 can be implemented in a number of different forms, as shown in the figure. For example, it can be implemented as a standard server 1420, or multiple times in a group of such servers. In addition, it can be implemented in a personal computer such as a laptop computer 1422. It can also be implemented as part of a rack server system 1424. Alternatively, components from the computing device 1400 can be combined with other components in a mobile device (not shown), such as a mobile computing device 1450. Each of such devices can contain one or more of the computing device 1400 and the mobile computing device 1450, and an entire system can be made up of multiple computing devices communicating with each other.

The mobile computing device 1450 includes a processor 1452, a memory 1464, an input/output device such as a display 1454, a communication interface 1466, and a transceiver 1468, among other components. The mobile computing device 1450 can also be provided with a storage device, such as a micro-drive or other device, to provide additional storage. Each of the processor 1452, the memory 1464, the display 1454, the communication interface 1466, and the transceiver 1468, are interconnected using various buses, and several of the components can be mounted on a common motherboard or in other manners as appropriate.

The processor 1452 can execute instructions within the mobile computing device 1450, including instructions stored in the memory 1464. The processor 1452 can be implemented as a chipset of chips that include separate and multiple analog and digital processors. The processor 1452 can provide, for example, for coordination of the other components of the mobile computing device 1450, such as control of user interfaces, applications run by the mobile computing device 1450, and wireless communication by the mobile computing device 1450.

The processor 1452 can communicate with a user through a control interface 1458 and a display interface 1456 coupled to the display 1454. The display 1454 can be, for example, a TFT (Thin-Film-Transistor Liquid Crystal Display) display or an OLED (Organic Light Emitting Diode) display, or other appropriate display technology. The display interface 1456 can comprise appropriate circuitry for driving the display 1454 to present graphical and other information to a user. The control interface 1458 can receive commands from a user and convert them for submission to the processor 1452. In addition, an external interface 1462 can provide communication with the processor 1452, so as to enable near area communication of the mobile computing device 1450 with other devices. The external interface 1462 can provide, for example, for wired communication in some implementations, or for wireless communication in other implementations, and multiple interfaces can also be used.

The memory 1464 stores information within the mobile computing device 1450. The memory 1464 can be implemented as one or more of a computer-readable medium or media, a volatile memory unit or units, or a non-volatile memory unit or units. An expansion memory 1474 can also be provided and connected to the mobile computing device 1450 through an expansion interface 1472, which can include, for example, a SIMM (Single In Line Memory Module) card interface. The expansion memory 1474 can provide extra storage space for the mobile computing device 1450, or can also store applications or other information for the mobile computing device 1450. Specifically, the expansion memory 1474 can include instructions to carry out or supplement the processes described above, and can include secure information also. Thus, for example, the expansion memory 1474 can be provide as a security module for the mobile computing device 1450, and can be programmed with instructions that permit secure use of the mobile computing device 1450. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1464, the expansion memory 1474, or memory on the processor 1452. In some implementations, the computer program product can be received in a propagated signal, for example, over the transceiver 1468 or the external interface 1462.

The mobile computing device 1450 can communicate wirelessly through the communication interface 1466, which can include digital signal processing circuitry where necessary. The communication interface 1466 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1468 using a radio-frequency. In addition, short-range communication can occur, such as using a Bluetooth, WiFi, or other such transceiver (not shown). In addition, a GPS (Global Positioning System) receiver module 1470 can provide additional navigation- and location-related wireless data to the mobile computing device 1450, which can be used as appropriate by applications running on the mobile computing device 1450.

The mobile computing device 1450 can also communicate audibly using an audio codec 1460, which can receive spoken information from a user and convert it to usable digital information. The audio codec 1460 can likewise generate audible sound for a user, such as through a speaker, e.g., in a handset of the mobile computing device 1450. Such sound can include sound from voice telephone calls, can include recorded sound (e.g., voice messages, music files, etc.) and can also include sound generated by applications operating on the mobile computing device 1450.

The mobile computing device 1450 can be implemented in a number of different forms, as shown in the figure. For example, it can be implemented as a cellular telephone 1480. It can also be implemented as part of a smart-phone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A system for monitoring and responding to an event in a facility using electronic emergency operating procedures (EOPs), the system comprising:
a supervisory computer system of the facility, the supervisory computer system being configured to perform operations comprising:
receiving facility operational data from at least one facility data source;
detecting, based on the facility operational data, an event in the facility;
retrieving, from a data store, logic for executing an EOP set of steps, wherein the EOP is identified for mitigating the detected event;
executing the logic to determine one or more of conditions, steps, and manual actions to be performed to mitigate the detected event;
generating and transmitting instructions to one or more of a plurality of user devices to present, as graphical user interface (GUI) displays, a dashboard with the one or more conditions, steps, and manual actions to be performed, wherein the dashboard presents an electronic version of the EOP set of steps; and
while executing the logic, iteratively:
determining whether the one or more conditions, steps, and manual actions are completed by the supervisory computer system or manually by a user based on user input received from the one or more of the plurality of user devices; and
generating and transmitting updated instructions to the one or more of the plurality of user devices to present the dashboard with indications indicating that the one or more conditions, steps, and manual actions are completed;
a plurality of user devices in network communication with the supervisory computer system, wherein each of the plurality of user devices are configured to perform operations comprising:
presenting the dashboard with real-time updates of a status of completing the EOP set of steps to mitigate the detected event;
receiving user input indicating verification of the one or more conditions, steps, and manual actions to complete for the EOP set of steps; and
transmitting the user input to the supervisory computer system, wherein the supervisory computer system is configured to (i) iteratively determine, based on the user input, whether the one or more conditions, steps, and manual actions are completed and (ii) generate and transmit the updated instructions to the one or more of the plurality of user devices to present the dashboard with indications indicating that the one or more conditions, steps, and manual actions are completed.

2. The system of claim 1, wherein the retrieved logic includes, for each step in the EOP set of steps, data input mapping, step logic, output fields and information, user input prompts and verifications, and links to one or more next steps in the EOP set of steps.

3. The system of claim 1, wherein the supervisory computer system performs operations further comprising:
recording the one or more conditions, steps, and manual actions that are completed by the supervisory computer system or manually by the user based on the user input received from the one or more of the plurality of user devices; and
determining training instructions for at least one user in the facility based on the recorded conditions, steps, and manual actions, wherein determining the training instructions further comprises determining, for each step of the EOP set of steps, whether the step was performed according to one or more step-completion criteria.

4. The system of claim 3, wherein recording comprises generating time sequence data of progress through each step of the EOP set of steps.

5. The system of claim 1, wherein the supervisory computer system is configured to execute computer logic to automatically perform at least one of the one or more conditions, steps, and manual actions to complete for the EOP set of steps.

6. The system of claim 5, wherein the computer logic is supported by a programmed model, the model having been trained to determine when to prompt one or more users at the plurality of user devices to perform at least one of the manual actions or a verification action during completion of the EOP set of steps.

7. The system of claim 1, wherein the electronic version of the EOP comprises an action response column and a response not obtained column.

8. The system of claim 1, wherein the electronic version of the EOP further comprises an indication of whether a continuous action is required during completion of the EOP set of steps.

9. The system of claim 1, wherein presenting the dashboard with real-time updates of a status of completing the EOP set of steps to mitigate the detected event comprises presenting output for completion of a step of the EOP set of steps in a first indicia and presenting output for incompletion of a step of the EOP set of steps in a second indicia.

10. The system of claim 1, wherein the operations further comprise:
detecting a system or network failure; and
generating and returning instructions to at least one of the plurality of user devices for continuing through the EOP set of steps within a system or network connection.

11. The system of claim 10, wherein the instructions prompt a user at the at least one user device to continue through the EOP set of steps using a paper-version of the EOP set of steps.

12. The system of claim 10, wherein the operations further comprise: printing information for each completed step in the EOP set of steps to a printer or another computing device, the another computing device comprising an electronically persistent display.

13. The system of claim 1, wherein the operations further comprise:
storing data corresponding to completion of the EOP set of steps in a plurality of bits that are maintained at a plurality of redundant and secure memory locations, wherein the data is recoverable from at least a portion of the plurality of redundant and secure memory locations when at least one of the redundant and secure memory locations is compromised.

14. The system of claim 13, wherein the at least one of the redundant and secure memory locations is compromised by a bitflip event during the detected event in the facility.

15. The system of claim 10, wherein in response to detecting a system or network failure, the operations further comprise generating and transmitting instructions to a temporary power source that causes the temporary power source to provide power to the at least one of the plurality of user devices,
wherein, in response to receiving the power from the temporary power source, the at least one of the plurality of user devices is configured to display a static version of the EOP set of steps, the static version presenting information indicating progress through the EOP set of steps that was displayed at the at least one of the plurality of user devices before the system or network failure.

16. The system of claim 10, wherein the operations further comprise:
detecting that the computer or network failure is resolved;
receiving, from the at least one of the plurality of user devices, a scan of a paper version of the EOP set of steps that was used by a respective user to complete the EOP set of steps during the computer or network failure;
processing the scan of the paper version of the EOP set of steps to identify user-inputted information in the paper version of the EOP set of steps that corresponds to completion of the EOP set of steps during the computer or network failure;
automatically populating the electronic version of the EOP set of steps with the identified user-inputted information in the paper version of the EOP set of steps; and
returning the populated electronic version of the EOP set of steps to the at least one of the plurality of user devices,
wherein, based on a determination that the detected event is ongoing, the populated electronic version of the EOP set of steps is used, at the at least one of the plurality of user devices, to continue the completion of the EOP set of steps.

17. A system comprising:
a digital EOP device providing an electronic EOP interface; and
a physical document providing a physical EOP interface,
wherein the electronic EOP interface is configured to replicate the physical EOP interface.

18. The system of claim 17, wherein the electronic EOP interface comprises an action response column and a response not obtained column that replicate corresponding columns in the physical EOP interface.

19. The system of claim 17, wherein the electronic EOP interface further comprises an informational page presented concurrently with an EOP set of steps, the informational page (i) presenting information about performing each of the EOP set of steps and (ii) replicating an informational page of the physical EOP interface.

20. The system of claim 17, wherein the electronic EOP interface further comprises presenting output for completion of a step of an EOP set of steps in a first indicia and presenting output for incompletion of a step of the EOP set of steps in a second indicia.
